(19) United States
(12) Patent Application Publication
(10) Pub. No.: US 2005/0177394 A1
(43) Pub. Date: Aug. 11, 2005

(54) Examination management system and examination management method

(75) Inventors: Ryoichi Hosoya, Ichikawa (JP); Nobuaki Matsubara, Saitama (JP); Hiroyuki Araki, Tokyo (JP); Hideki Yasuda, Tokyo (JP); Shinichi Omori, Tokyo (JP); Masafumi Kobayashi, Sagamihara (JP); Yoshinori Matsumoto, Tokyo (JP); Kazuyuki Inokihara, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 10/992,388

(22) Filed: Nov. 18, 2004

(30) Foreign Application Priority Data
Dec. 2, 2003 (JP) 2003-402465

(51) Int. Cl. G06F 17/60

(52) U.S. Cl. 705/2

(57) ABSTRACT

An examination management system according to the present invention comprises implemented information input means for inputting implemented information including information related to a content of implementation of medical service, implemented regarding an examination and information related to a report about the medical service, implemented information storing means for storing the implemented information input by the implemented information input means, implemented information acquisition means for obtaining the implemented information related to the report from the implemented information storage means by using information indicating the same examination of the same patient matching a key, report comparison means for the comparison of a plurality of reports obtained by the implemented information acquisition means, and report comparison result display means for the display of the result of the comparison by the report comparison means.

### CROSS REFERENCE TO RELATED APPLICATIONS

This application claims benefit of Japanese application No. 2003-402465, filed Dec. 2, 2003, the contents of which are incorporated by this reference.

### BACKGROUND OF THE INVENTION

1. Field of the Invention

The present invention relates to an examination management system and an examination management method for managing an examination device such as an electronic endoscope device or the like.

2. Description of the Related Art

Conventionally, there are systems in which information obtained during an endoscope examination can be input and referred to. In such conventional systems, implementation information pertaining to an examination can be input and the input implementation information can be utilized for an account transaction history. (See Japanese patent application publication No. 2002-73615, for example) Also, in the above conventional system, when inputting a report, a characteristic image selected from recorded images can be attached to a report as a representative image indicating the result of an examination (i.e. the characteristic image is displayed simultaneously with the report information in an “Input of report” window) . Further, the position of the photograph can be separately input on the schema diagram in order to indicate on which organ (site) the photography was conducted.

### SUMMARY OF THE INVENTION

According to one aspect of the present invention, an examination management system of the present invention is characterized in that the system comprises an implemented information input unit for the input of implemented information, including information related to the content of implementation of medical services implemented regarding examinations and information related to a report of the medical service, an implemented information storage unit for storing the implemented information input to the implemented information input unit, an implemented information query unit for obtaining implementation information related to the report from the implemented information storage unit by using information indicating an examination of a patient matching a key, a report comparison unit for comparing a plurality of reports obtained by the implemented information query unit, and a report comparison result display unit for displaying the results of the comparison by the report comparison unit.

### BRIEF DESCRIPTION OF THE DRAWINGS

The present invention will be more apparent from the following detailed description when the accompanying drawings are referenced.

FIG. 1 shows a hardware configuration of an endoscope examination management system according to a first embodiment of the present invention;

FIG. 2 shows a software configuration of the endoscope examination management system of the present invention;

FIG. 3 shows transition in the activation/termination of the system;

FIG. 4 shows an “Activation/termination of system” window 101;

FIG. 5 shows a configuration of tables and master files managed by a database 21 of a server 5;

FIG. 6 shows an “Examination transaction” main window 58 opened when an “Examination transaction” icon 52 is selected;

FIG. 7 shows transitions in the “Examination transaction” main window as a first example;

FIG. 8 shows transitions in the “Examination transaction” main window as a second example;

FIG. 9 shows transitions in the “Examination transaction” main window as a third example;

FIG. 10 shows a “List of not arrived patients” window 1060;

FIG. 11 shows a “List of arrived patients” window 72;

FIG. 12 shows a “List of examinations whose preprocedure is not registered” window 76;

FIG. 13 shows a “List of patients not photographed” window 81;

FIG. 14 shows a “List of examinations whose implementation is not transmitted” window 87;

FIG. 15 shows a “List of examinations whose report is not transmitted” window 92;

FIG. 16 shows a “List of examination status” window 97;

FIG. 17 shows a “Registration of in-department order” window 1101;

FIG. 18 is a flowchart showing the flow of an examination;

FIG. 19 shows a “Suspension of examination” window 69;

FIG. 20 shows a “Confirmation of order detail” window 68;

FIG. 21 shows an “Input of preprocedure” window 78;

FIG. 22 shows a “Modification” window 123 for notandum (patient profile information);

FIG. 23 shows a “Photography” window 83;

FIG. 24 shows a displayed content of a “Selection” menu 137;

FIG. 25 shows the “Input of implementation” window 89;

FIG. 26 shows the “Input of report” window 94;

FIG. 27 shows an example of input of remarks;

FIG. 28 shows a “Term” window 164;

FIG. 29 shows a “Comment” menu 1168;

FIG. 30 shows an example when an “Instruction after examination” 169 is specified;

FIG. 31 shows a state where the display is switched by selecting the “Switch displayed information” button 1181 (FIG. 26);

FIG. 32 shows an opened state of the “Edit schema image” window 184;

FIG. 33 shows an opened state of the “Acquisition of external image” window 192 when the “Acquire schema” button 191 is selected;

FIG. 34 shows a “Verification” window 177;

FIG. 35 shows a “Conference” window 201 opened upon the login by selecting the “Conference” icon 53 on the “Activation/termination of system” window 101;

FIG. 36 shows a “Display of image” window 204 opened by selecting the “Display of image” on the above menu;

FIG. 37 shows an example of the layout when the “Display images in comparison” 208 is selected;

FIG. 38 shows an example of the layout when the “Display simultaneously with past examination” button 209 is selected;

FIG. 39 shows a “Statistics/history” window opened upon login by selecting the “Statistics/history” icon 54 on the “Activation/termination of system” window 101;

FIG. 40 shows a “Management function” window opened upon login by selecting the “Management function” icon 55 on the “Activation/termination of system” window 101;

FIG. 41 shows the “Contrast and incorporate order” window opened by selecting the examination which it is desired to conduct the contrast and incorporate operation on from the list 1214 in FIG. 40;

FIG. 42 shows a configuration of table/master file of examination tables according to a second embodiment of the present invention;

FIG. 43 shows data stored in the implementation managing table according to the second embodiment of the present invention;

FIG. 44 shows tables for managing the report information according to the second embodiment of the present invention;

FIG. 45 shows tables for managing preprocedures according to the second embodiment of the present invention;

FIG. 46 shows tables for managing the image information according to the second embodiment of the present invention;

FIG. 47 shows a transaction flow of an endoscope examination;

FIG. 48 shows an example of “Input of implementation” window for input of the implementation information in step S37 of FIG. 47;

FIG. 49 shows an example of the “Input of report” window for input of remarks of report, diagnosis and procedural information in step S38 and step S42 of FIG. 47;

FIG. 50 shows an example of a window for preparing a report and for registering the report in step S38 and step S42 of FIG. 47;

FIG. 51 shows a configuration of process functions for realizing the second embodiment of the present invention;

FIG. 52 shows an example of display of the result of the comparison;

FIG. 53 shows a configuration of a process function for realizing a third embodiment of the present invention;

FIG. 54 shows an example of a graph indicating respective accuracies for each disease for which the diagnosis was implemented;

FIG. 55 shows an example of a graph indicating respective accuracies for each site for which the diagnosis was implemented;

FIG. 56 shows an example of a graph indicating respective accuracies for each implemented technique;

FIG. 57 shows an example of a graph indicating respective accuracies for each doctor;

FIG. 58 shows an example of a graph indicating respective accuracies for each instrument used;

FIG. 59 shows an example of a graph indicating respective accuracies for each number of hours of examination;

FIG. 60 shows an example of a graph indicating respective accuracies for each of a number of photographs taken during examination;

FIG. 61 shows an example of a graph indicating respective accuracies for each dye used for the lesion upon diagnosis during examination;

FIG. 62 shows a configuration of the process function for realizing a fourth embodiment of the present invention; and

FIG. 63 shows an example of displaying the percentage of the diagnosis for techniques such as surgical procedures.

### DESCRIPTION OF THE PREFERRED EMBODIMENTS

Hereinafter, embodiments of the present invention are explained by referring to the drawings.

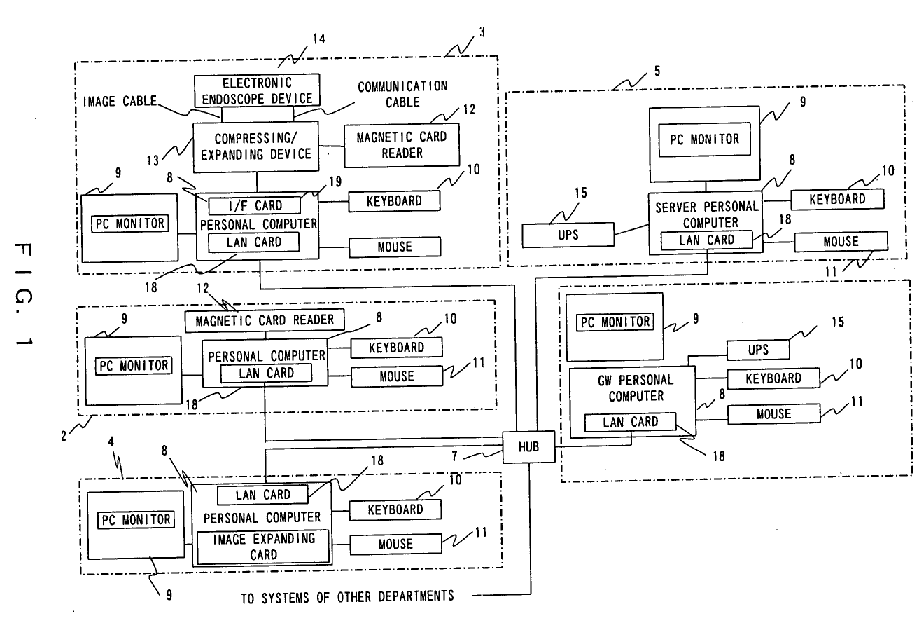

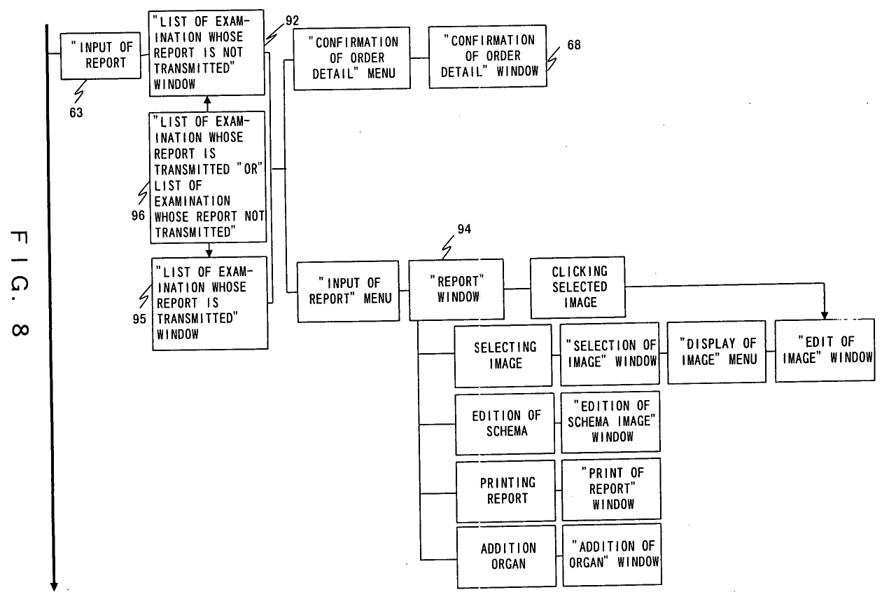

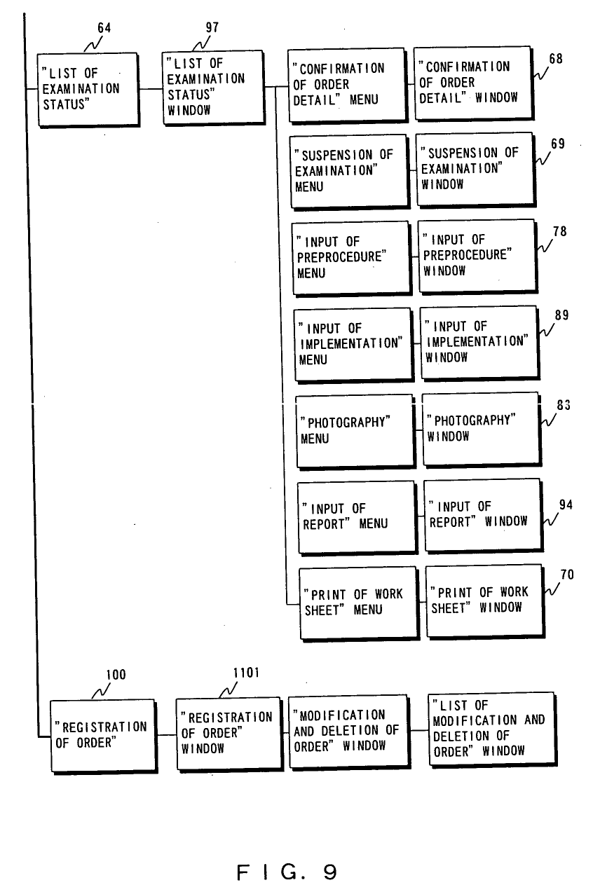

FIGS. 1 to 41 explain a first embodiment.

FIG. 1 shows a hardware configuration of an endoscope examination management system according to the first embodiment.

In FIG. 1, the endoscope examination management system of the present invention mainly comprises a GW1 (gateway) for exchanging data with other departments in a hospital, a reception terminal 2 for processing an application for an examination, an input/examination terminal 3 for conducting examinations, a search terminal 4 for display and input of images and various kinds of information, and a server 5 for recording data. The above respective devices are connected to one another via a network (LAN) distributed by a HUB 7.

Also, each device includes, as basic components, a personal computer (PC) 8, a PC monitor 9, a keyboard 10, and a mouse 11 and is connected to the network via a LAN card 18 included in the personal computer 8.

The GW 1 comprises, in addition to the above basic components, a UPS (uninterrupted power supply) 15 in order to mitigate sudden power failure.

The reception terminal 2 comprises a magnetic card reader 12 in addition to the above basic components. The reception terminal is installed at a reception desk or the like in a department in order to be used for reception transactions for examinations.

The input/examination terminal 3 comprises, in addition to the above basic components, a magnetic card reader 12, and a compressing/expanding device 13. The compressing/expanding device 13 is connected to an electronic endoscope device 14 via an image cable and a communication cable. Also, the compressing/expanding device 13 is connected to the personal computer 8 via an I/F card 19 included in the personal computer 8. The input/examination terminal is installed in an examination room in order that it can be used when the examination is conducted.

The search terminal 4 comprises only the above basic components and is installed in a conference room or the like in order to be used for conference transactions.

The server 5 comprises, in addition to the above basic components, the UPS 15 in order to mitigate sudden power failure.

Also, the electronic endoscope device 14 comprises an electronic endoscope and a processor device for processing and the output of an image signal, the configuration of which is the same as that of a well known electronic endoscope device, so that details thereof are not shown in drawings. The electronic endoscope comprises an elongated insertion unit to be inserted into the body and an operating unit attached to the distal end of the insertion unit. The operation unit is provided with a release switch for issuing a release order, so that an image can be recorded by selecting the release switch.

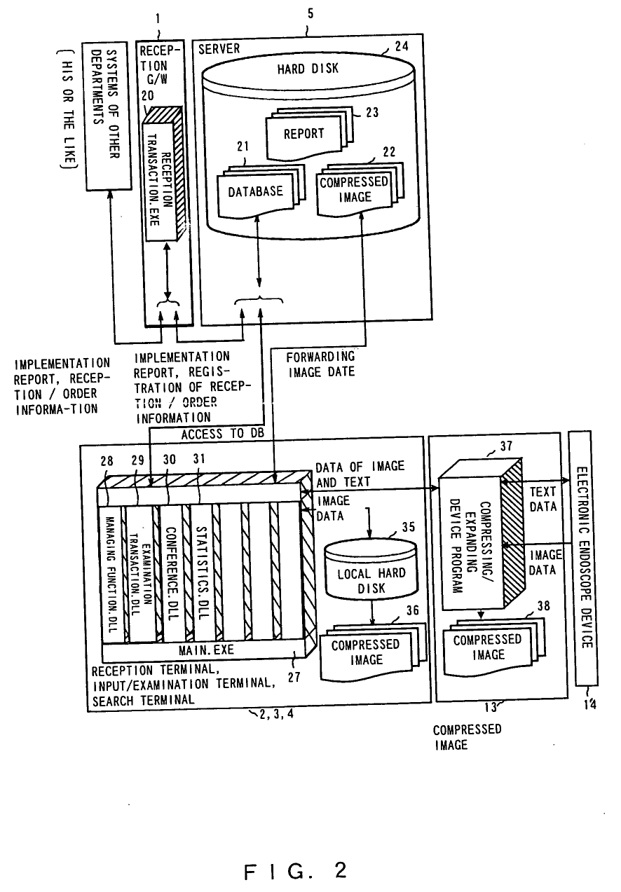

FIG. 2 shows the software configuration of the endoscope examination management system of the present invention.

In FIG. 2, various application software and databases and the like are installed on the hard disk of each device, in order to be operated thereon.

On the GW 1, GW application software 20 is operated.

On a hard disk 24 of the server 5, a database 21 is operated and a compressed image 22 photographed by the input/examination terminal 3 and report information 23 of the examination are recorded and stored.

The reception terminal 2 and the search terminal 4 employ the same software configurations as one another and the main application software 27 is operated on the above three devices. The main application software 27 mainly comprises an examination transaction DLL (dynamic link library) 29, a conference DLL 30, a statistics/history DLL 31 and a management function DLL 28. A compressed image 36 can be temporally stored on a hard disk 35.

As described above, the reception terminal 2 and the search terminal 4 employ the same software configurations as one another. Therefore, the differences between the three devices are the purposes for which they are used, which depend on where the devices are installed.

However, only the input/examination terminal 3 is different from the others in that the compressing/expanding device 13 for compressing/expanding image data is connected to the terminal 3 so that an image can be photographed during the examination. In the compressing/expanding device 13, a compressing/expanding device program 37 is operated and a compressed image 38 can be temporally stored in the memory of the compressing/expanding device 13. The compressing/expanding device 13 is connected to the electronic endoscope device 14.

Operations of the endoscope examination management system of the present invention will be explained.

Firstly, the types of information regarding an examination as well as which information is to be managed by the management system of the present invention are explained.

The information to be managed by the management system of the present invention mainly comprises the following four kinds of information.

1) Patient Information

Basic Patient Information

Basic patient information is for identifying one patient, and comprises “patient id”, “full name”, “birth date”, “sex” and the like. The “patient id” is a number uniquely corresponding to a patient so that each patient can be identified.

Patient Profile Information

The patient profile information is for indicating characteristics and conditions of each patient, and comprises “blood type”, “height/weight”, “allergy”, “disability”, “infection”, “disease/notandum”, “result of sample examination” and “prior medication information”.

2) Examination Order Information

Examination order information is with relation to the order of examinations and is used in the case that an examination order is issued to the endoscopy department by external departments. The examination order information comprises order key information (“order number”, “date of issue” and the like), order source information (“name of department issuing order”, “name of doctor issuing order”, “date of order” and the like), order information (“name of disease to be examined”, “purpose of examination”, “type of examination”, “item of examination”, “site to be examined”, “comments”, “schema image” and the like), examination reservation information (“date of examination”, “time of examination” and the like), and the like. The above information is transmitted to each system of departments of the HIS (hospital information system). The order key information is for uniquely identifying one examination order.

3) Examination Implementation Information (Account Information)

Examination implementation information regards the content of the implementation of the examination, and comprises “time and date of implementation”, “operator”, “place of implementation”, “technique”, “medicine”, “instrument” and the like. Information such as “technique” of implementation, or “medicine” used, “instrument” used and the like are used for accounting purposes. This information is transmitted to HIS from the endoscopy department system so that the transaction is conducted in an accounting system of the HIS.

4) Examination Result Information (Report Information)

The examination result information regards the examination result, and becomes a report corresponding to an examination order and comprises “date of report”, “reporting person”, “diagnosis”, “remarks”, “procedure”, “comment”, “notice/instruction after examination”, “image”, “schema image” and the like. The above information can be referred to in a medical image filing system provided in the endoscopy department and, can also be referred to by systems in other departments by being transmitted from the present system to HIS. Therefore, the examination result (report) can be referred to by a department which issued an examination order.

Next, transition of windows for respective functions is explained.

<Activation/Termination of System>

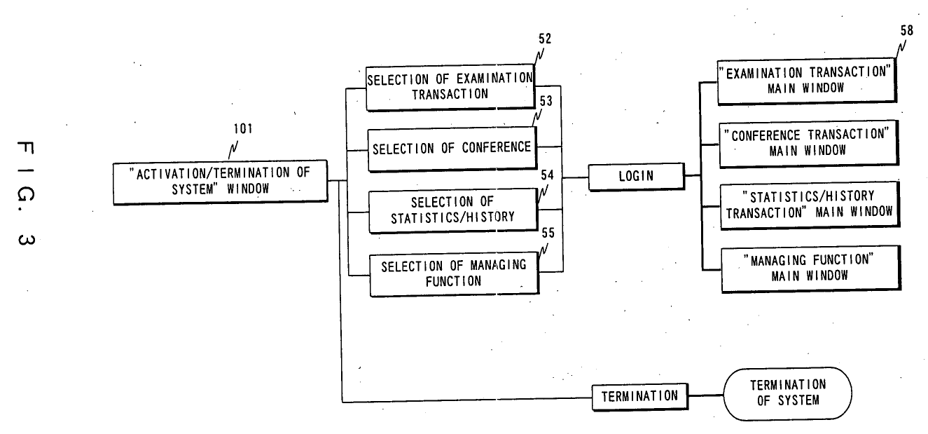

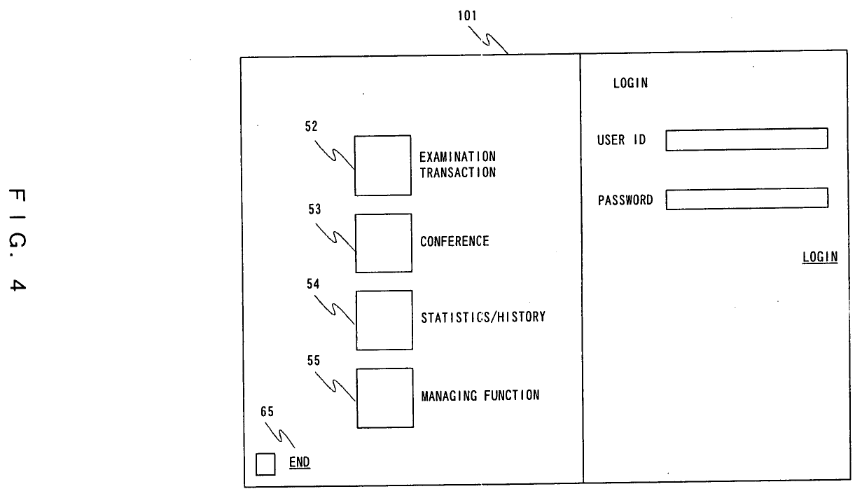

FIG. 3 shows a transition in the activation/termination of the system. FIG. 4 shows an “Activation/termination of system” window 101.

When a user ID and a password are input and a login operation is performed, after selecting an “Examination transaction” icon 52, a “Conference” icon 53, a “Statistics/history” icon 54 or a “Management function” icon 55, corresponding to the DLLs 28 to 31 of the main application software 27, corresponding functions can be accessed.

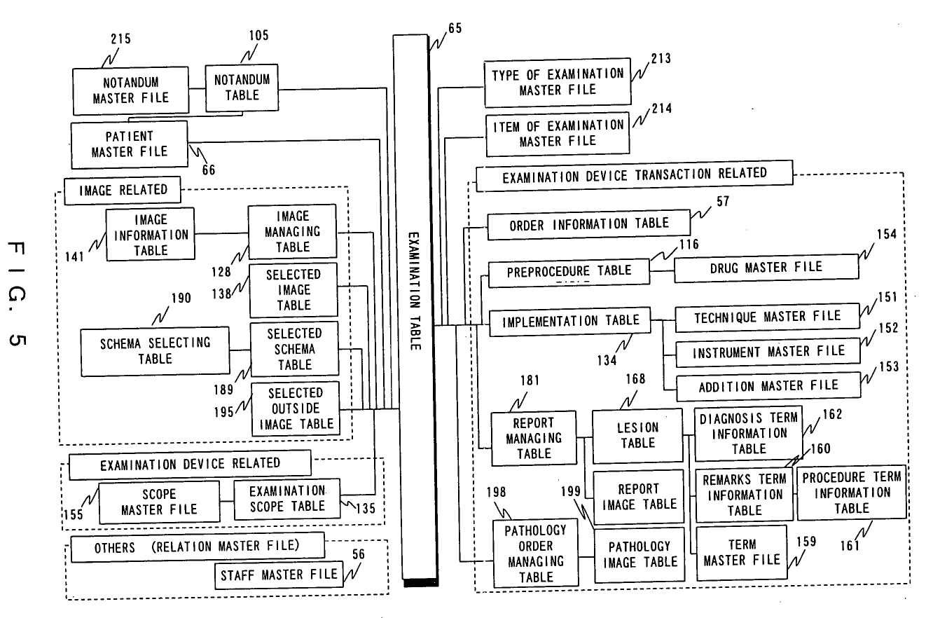

FIG. 5 shows a configuration of tables and master files managed by the database 21 of the server 5.

The user ids and the passwords are managed on the staff master file 56 so that the input user ID and password are compared with the pair of the user ID and password managed in the staff master file 56. If there is no difference the input user ID and password are verified and appropriate functions are activated. Also, a user ID can be input directly as an ID number instead of selecting an ID number from a combo box or the like so that the burden of selection is alleviated. Further, the system is terminated when an “End” button 65 is selected.

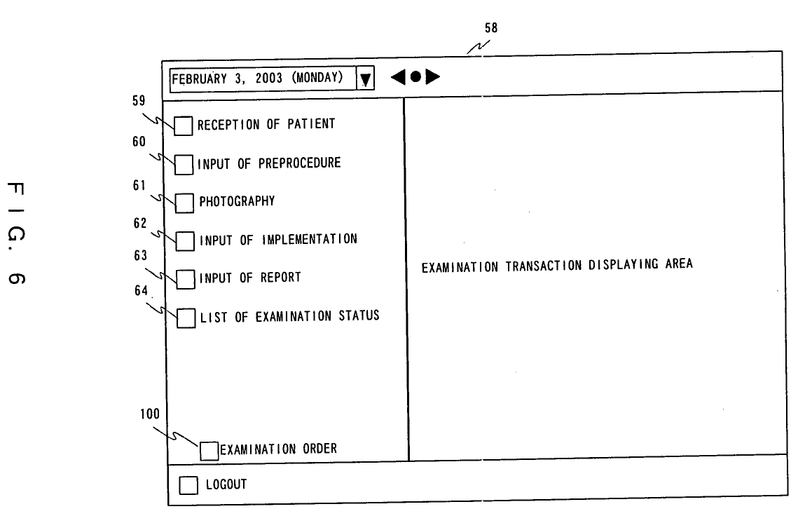

FIG. 6 shows an “Examination transaction” main window 58 opened when the “Examination transaction” icon 52 is selected.

On the left portion of the window, icons corresponding to the transactions are arranged so that respective windows are opened when the icons are selected. There are a “Reception of patient” icon 59, an “Input of preprocedure” icon 60, a “Photography” icon 61, an “Input of implementation” icon 62, an “Input of report” icon 63, a “List of examination status” icon 64 and an “Examination order” button icon 100.

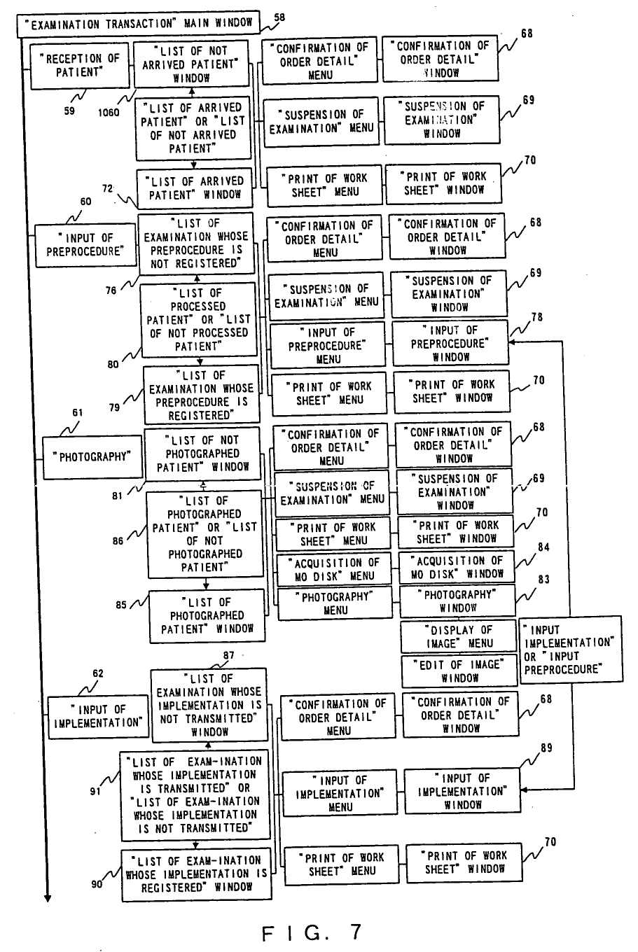

FIGS. 7 to 9 show transitions in the “Examination transaction” main window.

<Reception of Patient>

By selecting the “Reception of patient” icon 59, a “List of patients not arrived” window 75 is opened.

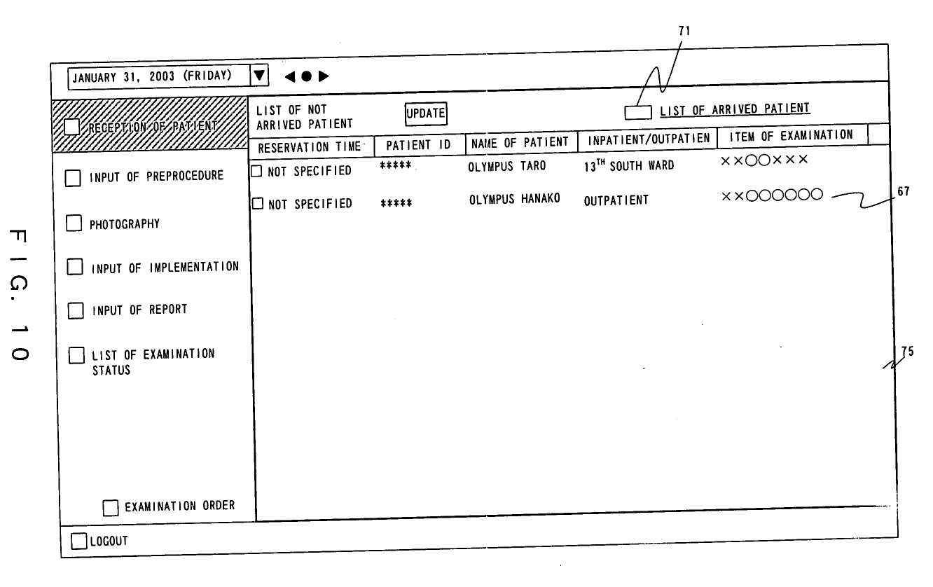

FIG. 10 shows a “List of patients not arrived” window 1060.

In this window, a “List patients not received only” 67 can be displayed by referring to examination status and a patient master file 66 managed on an examination table 65 by the data base 21. By selecting a menu displayed by selecting one item of the “List patients not received only” 67, a “Confirmation of order detail” window 68, a “Suspension of examination” window 69 and a “Print of work sheet” window 70 each regarding the examination for the selected item can be opened.

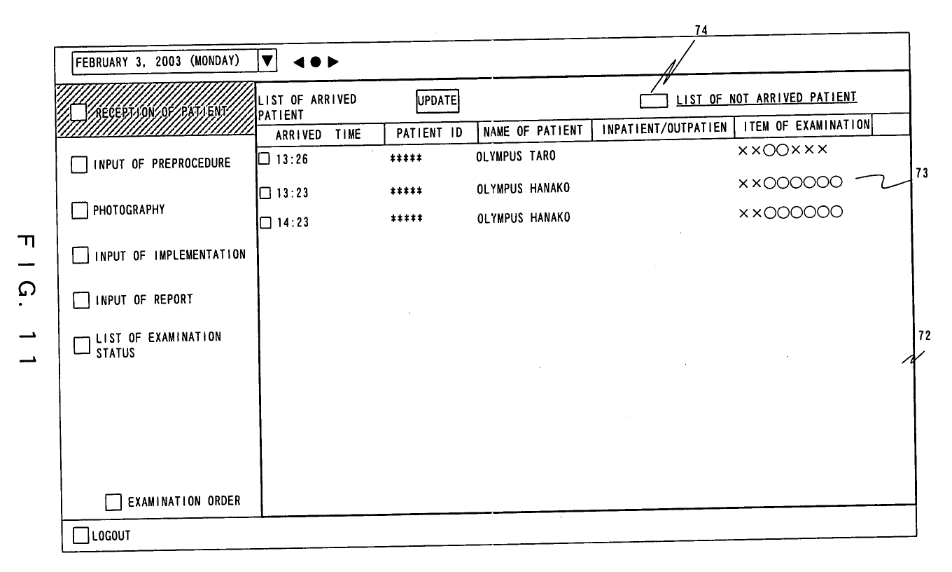

FIG. 11 shows a “List of arrived patients” window 72.

The “List of arrived patients” window 72 can be opened as shown in FIG. 11 by selecting a “List of arrived patients” button 71 on the “List of not arrived patient” window 1060. The “List of not arrived patients” window 1060 can also be opened by selecting the “List of not arrived patients” button 74 on the “List of arrived patients” window 72.

On the “List of arrived patients” window, a “List of arrived and received patients” 73 is displayed. The “List of arrived and received patients” 73 can display only the examinations whose examination status is received by referring to the examination table in the database 21.

<Input of Preprocedure>

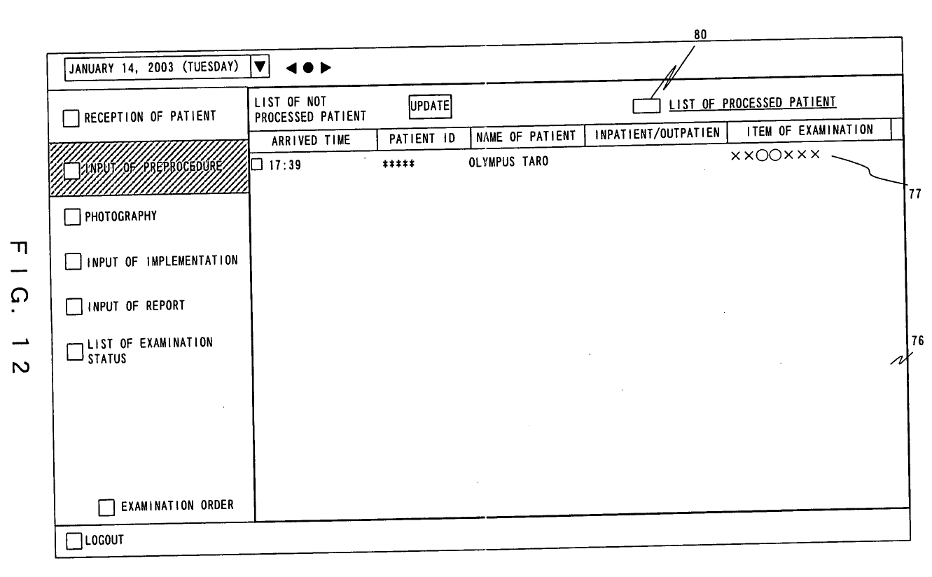

FIG. 12 shows a “List of examinations whose preprocedures are not registered” window 76.

By selecting the “Input of preprocedure” icon 60, the “List of examinations whose preprocedures are not registered” window 76 as shown in FIG. 12 can be opened. On the “List of examinations whose preprocedures are not registered” widow 76, a “List of examinations whose preprocedures are not registered” 77 can be displayed. (A list of examinations which are received and whose preprocedures are not registered can be displayed by referring to the examination table 65 in the database 21.)

By selecting a menu displayed by selecting one item of the “List of examinations whose preprocedures are not registered” 77, the “Confirmation of order detail” window 68, the “Suspension of examination” window 69 and the “Print of work sheet” window 70 each regarding the examination of the selected item, an “Input of preprocedure” window 78 can be opened.

Further, the transitions between the “List of examinations whose preprocedures are not registered” window 76 and the “List of examinations whose preprocedures are registered” window 79 can be conducted by selecting the “List of processed patients” button 80 (the “List of not processed patients” button) in the same manner as the transitions between the “List of not arrived patients” window 1060 and the “List of arrived patients” window 72.

<Photography>

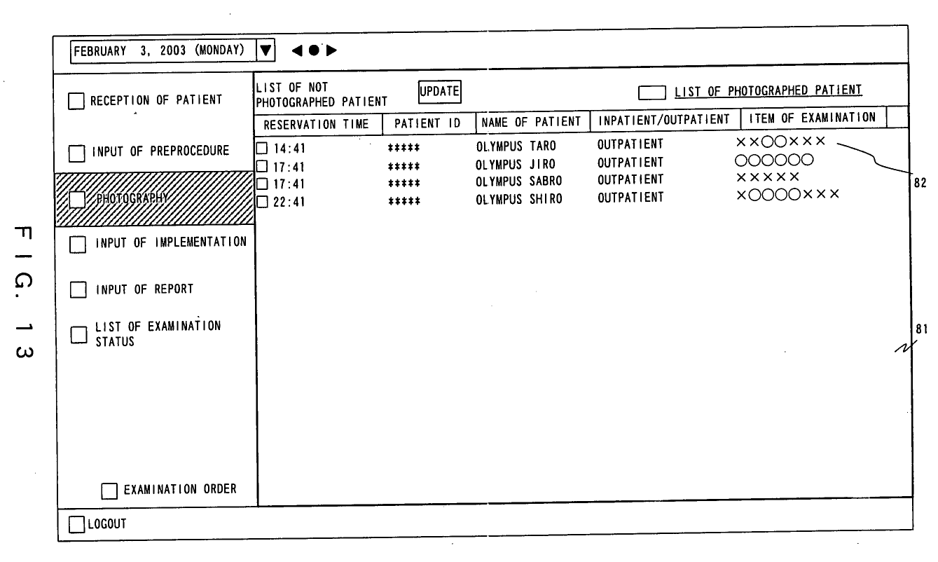

FIG. 13 shows a “List of not photographed patients” window 81.

By selecting the “Photography” icon 61, the “List of examinations whose preprocedures are registered of not photographed patients” window 81 as shown in FIG. 13 is opened. The “List of not photographed patients” window 81 can display a “List of examinations whose photography has not been conducted” 82. (A list of examinations which are received and whose photography has not been conducted can be displayed by referring to the examination table 65 in the database 21.) By selecting a menu displayed by selecting one item of the “List of not photographed patients” window 81, the “Confirmation of order detail” window 68, the “Suspension of examination” window 69 and the “Print of work sheet” window 70 each regarding the examination of the selected item, a “Photography” window 83 can be opened.

Further, by opening an “Acquisition of MO disk” window 84, image data stored on an MO disk can be registered instead of photography. Further, transition between the “List of not photographed patients” window 81 and the “List of photographed patients” window 85 can be conducted by selecting the “List of photographed patients” button 86 (“List of not photographed patients” button) in the same manner as the transition between the “List of not arrived patients” window 1060 and the “List of arrived patients” window 72.

<Input of Implementation>

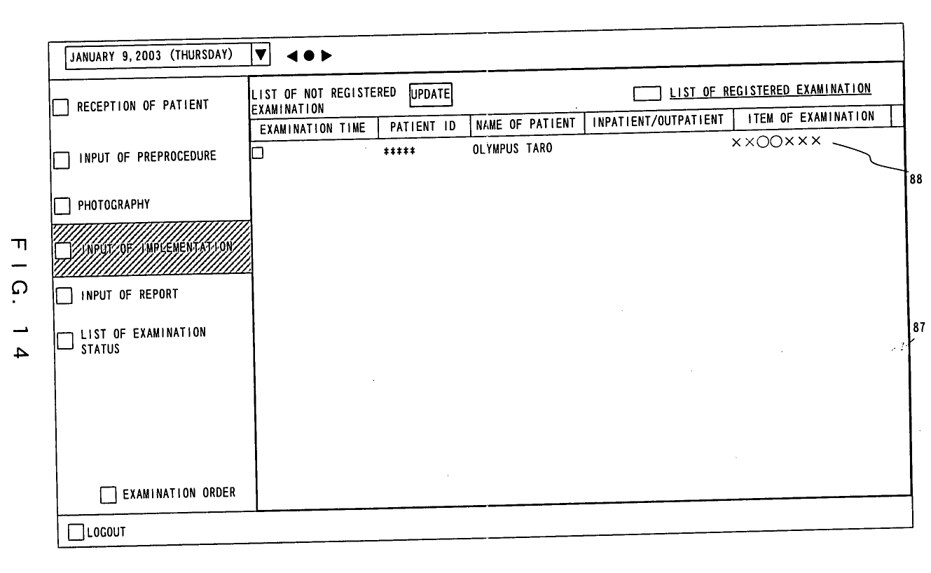

FIG. 14 shows a “List of examinations whose implementation has not been transmitted” window 87.

By selecting the “Input of implementation” icon 62, the “List of examinations whose implementation has not been transmitted” window 87 as shown in FIG. 14 is opened.

The “List of examinations whose implementation has not been transmitted” window 87 displays a “List of examinations whose implementation has not been transmitted” 88. (A list of examinations which are photographed and whose implementation information is not registered can be displayed by referring to the examination table 65 of the database 21.) By selecting a menu displayed by selecting one item of the “List of examinations whose implementation has not been transmitted” 88, the “Confirmation of order detail” window 68 and the “Print of work sheet” window 70 each regarding the examination of the selected item, an “Implementation” window 89 can be opened.

Further, transition between the “List of examinations whose implementation has not been transmitted” window 87 and the “List of examinations whose implementation is registered” window 90 can be achieved by selecting the “List of examinations whose implementation has been transmitted” button 91 (“List of examinations whose implementation has not been transmitted” button) in the same manner as the transition between the “List of not arrived patients” window 1060 and the “List of arrived patients” window 72.

<Input of Report>

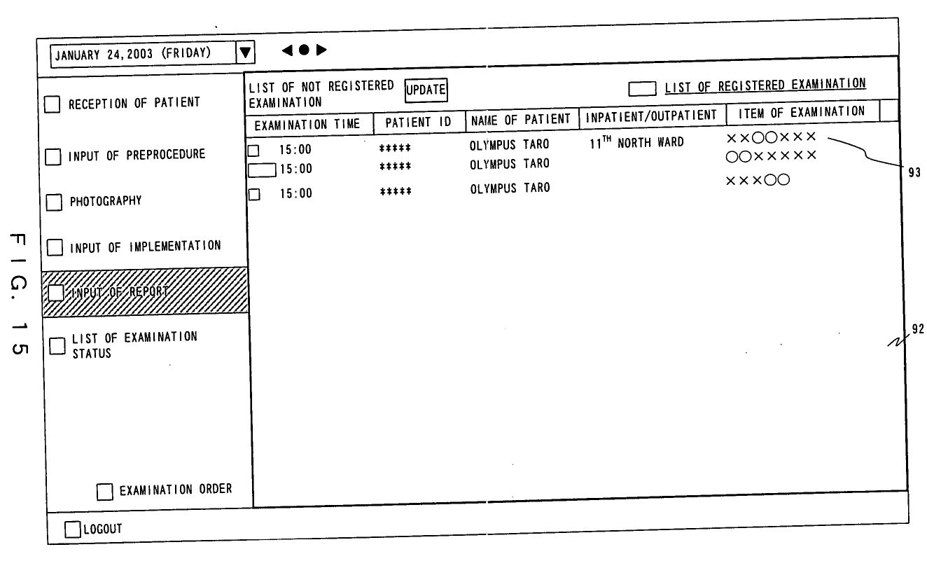

FIG. 15 shows a “List of examinations whose report has not been transmitted” window 92.

By selecting the “Input of report” icon 63, the “List of examinations whose report has not been transmitted” window 92 as shown in FIG. 15 is opened.

The “List of examinations whose report has not been transmitted” window 92 can display a “List of examinations whose report has not been transmitted” 93. (A list of examinations that have been photographed and whose report information has not been registered can be displayed by referring to the examination table 65 of the database 21.)

By selecting a menu displayed by selecting one item of the “List of examinations whose report has not been transmitted” 93, the “Confirmation of order detail” window 68 or the “Report” window 94 each regarding the examination for the selected item can be opened.

Further, the transition between the “List of examinations whose report has not been transmitted” window 92 and the “List of examinations whose reports are registered” window 95 can be conducted by selecting the “List of examinations whose reports are registered” button 96 (“List of examinations whose report has not been transmitted” button) in the same manner as the transition between the “List of not arrived patients” window 1060 and the “List of arrived patients” window 72.

<List of Examination Status>

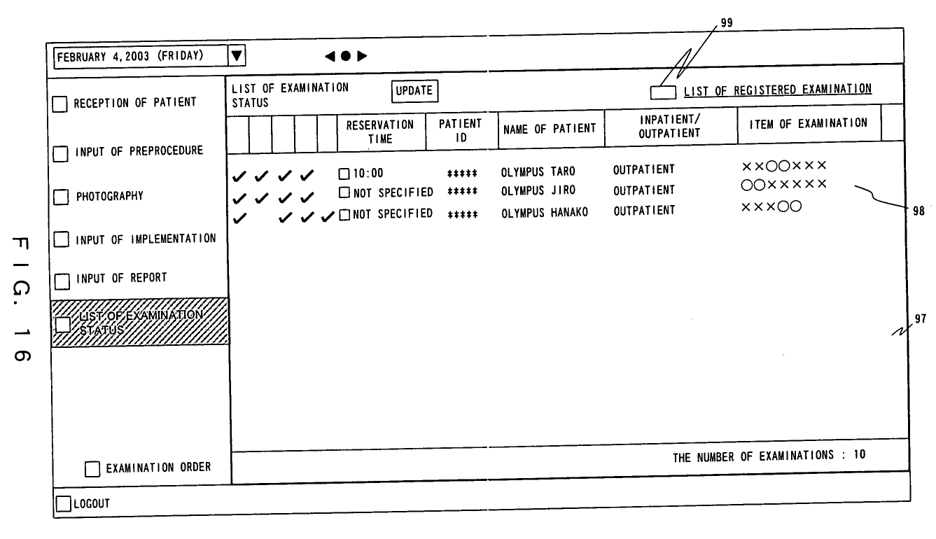

FIG. 16 shows a “List of examination status” window 97.

By selecting the “List of examination status” icon 64, the “List of examination status” window 97 as shown in FIG. 16 is opened.

The “List of examination status” window 97 can display a “List of the status of each examination” 98. (A list of the status of each examination can be displayed by referring to the examination table 65 of the database 21.)

Further, by selecting a menu displayed by selecting one item of the “List of the status of each examination” 98, the “Confirmation of order detail” window 68, the “Suspension of examination” window 69, the “Input of preprocedure” window 78, the “Input of implementation” window 89, the “Photography” window 83, the “Report” window 94 and the “Print of work sheet” window 70 each regarding the examination for the selected item can be opened.

Further, by selecting a “Print list” button 99, the list of the status of the examinations displayed in the “List of examination status” window 97 can be printed.

<Examination Order>

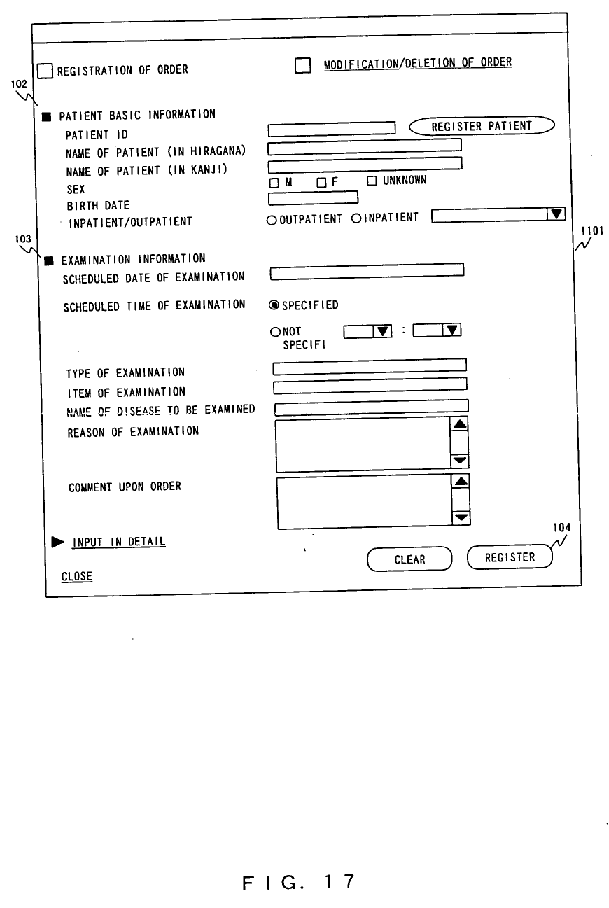

FIG. 17 shows a “Registration of in-department order” window 1101.

By selecting the “Examination order” button icon 100, the “Registration of in-department order” window 1101 as shown in FIG. 17 is opened.

The “Registration of in-department order” window 1101, is used for issuing an examination order in the system, including the “Registration of in-department order” window 1101 itself, when order information can not be received from the HIS. Patient information (patient id, name of patient, birth date, sex, inpatient/outpatient classification) 102 and examination information (scheduled date of examination), scheduled time of examination, type of examination, item of examination, name of disease to be examined, purpose of examination and comment upon order) 103 and the like can be input and by selecting a “Register” button 104, the input information is registered in the database 21 as the examination order. The patient information 102 is managed by the patient master file 66, and the examination information 103 is managed by an order information table 57.

Next, operations will be explained by following the flow of an examination.

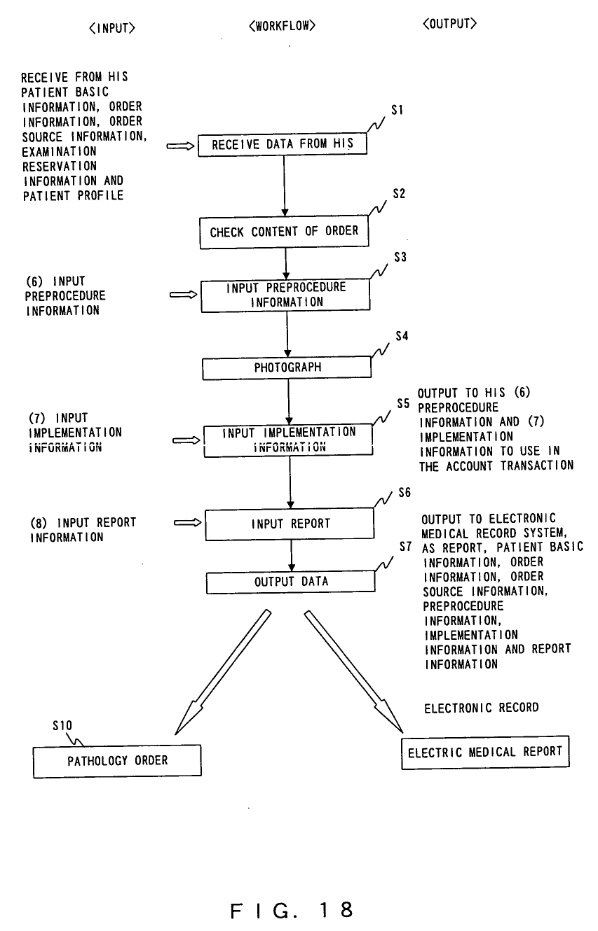

FIG. 18 is a flowchart showing the workflow of an examination.

<Step 1 (S1)>

When an examination order is issued from an external department to the endoscopy department, patient information (basic patient information and patient profile information) and examination order information (order information, order source information and examination reservation information) is transmitted from the HIS so that the system of the present invention receives the information. Specifically, GW application software 20 on the GW 1 receives information from the HIS, and the received information is registered in an examination table 65, a patient master file 66 and an order information table 57 of the database 21.

When the profile information of the patient is included with the received information, the profile information is associated with the patient master file and is registered in a notandum table 105.

Further, when the examination order can not be received from the HIS because the HIS is not available, the order can be issued by a department by opening the above described “Registration of in-department order” window 1101.

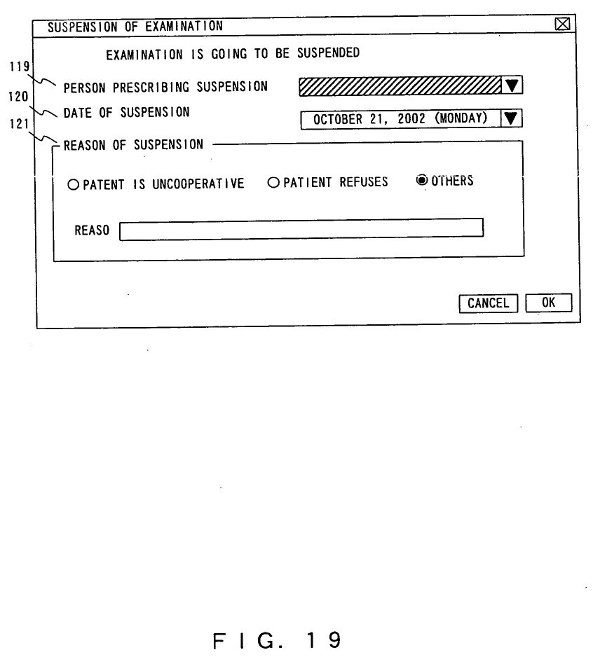

FIG. 19 shows the “Suspension of examination” window 69.

When it is desired that an examination is suspended, the above “Suspension of examination” window 69 is opened. In the “Suspension of examination” window, the person prescribing suspension 119, date of suspension 120 and reason for suspension 121 can be input, and are registered in an examination table of the database 21. Also, the status of the examination in the examination table is updated to a status of “Suspended”.

Upon suspension of an examination, a control is conducted under the following conditions.
(1) The examination can be suspended only before the photography is started
(2) The suspension of examination causes different processing from that of cancellation of an examination order, i.e. suspension of examination is not cancellation of an examination order (the examination order in the list of examinations is not deleted)
(3) The modification of an examination order or the cancellation thereof cannot be accepted by the HIS after the reception processing or after a closing time for the application for examination (the suspension of examination however, can be accepted)

The above conditions are included so that misunderstanding between doctors ordering examinations and examination staff does not occur.

Further, the above conditions are included so that a situations where an examination order is modified after the examination has been started, where personnel have not been informed of the cancellation of the examination order, and the like are avoided.

<Step 2 (S2)>

According to the system of the present invention, reservations are managed based on received examination reservation information, so that scheduled examinations can be displayed in correspondence with the status of the examination in list form, as above. In order to refer to the content of an order, the “Confirmation of order detail” window 68 is opened.

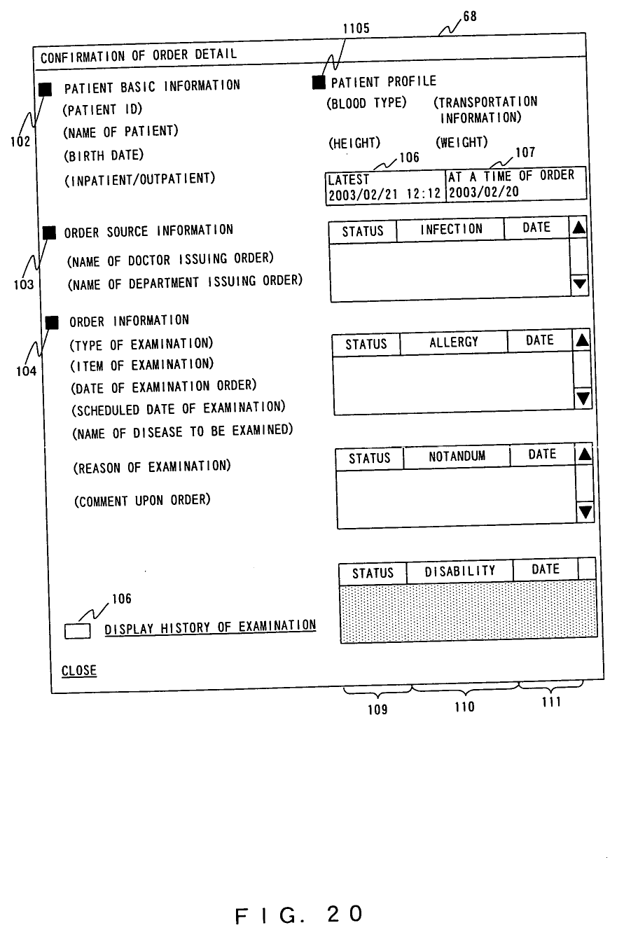

FIG. 20 shows the “Confirmation of order detail” window 68.

The reception terminal 2 and the input/examination terminal 3 include the same software as each other so that both the reception terminal 2 and the input/examination terminal 3 (or the search terminal 4) can refer to the above window.

The “Confirmation of order detail” window 68 mainly comprises a patient basic information display area 102, an order source information display area 103, an order information display area 104, a patient profile information display area 1105 and a “Display past examination” button 106.

As for the display of the patient profile information which is obtained from the notandum table 105 in the database 21, two kinds of patient profile information, i.e. the patient profile information obtained at the time when the order information was issued, and the most recently obtained patient profile information 108 are displayed with the dates that the information was obtained respectively. This is because there is a possibility that modification of the patient profile information has occurred between the issue of the examination order and the actual day of the examination in the case that a long period of time has elapsed between the day of the issue of the examination order and the actual day of the examination.

In addition, patient profile information 1105 is displayed together with examination date information 111 in addition to a status 109 and a name (infection, allergy information, notandum, disability information and the like) 110 so that the validity of information can be confirmed. The profile information of each patient as above is displayed by obtaining it from the notandum table of the database 21.

Further, as display of the patient profile status 109, statuses such as “?”, “Unknown”, “Not examined” and “Not input” are include in addition to the statuses corresponding to a definite result such as “+”, “Yes”, “−” and “No” so that the status is determined at all times.

Thereby, a situation causing a misunderstanding such that the user can not determine whether or not he/she can accept the status as “−” or “No” when the area for the profile status is blank is avoided.

<Step 3 (S3)>

Next, a window which is used upon conducting preprocedures on the patient, such as anesthetization or the like, before the examination, is explained.

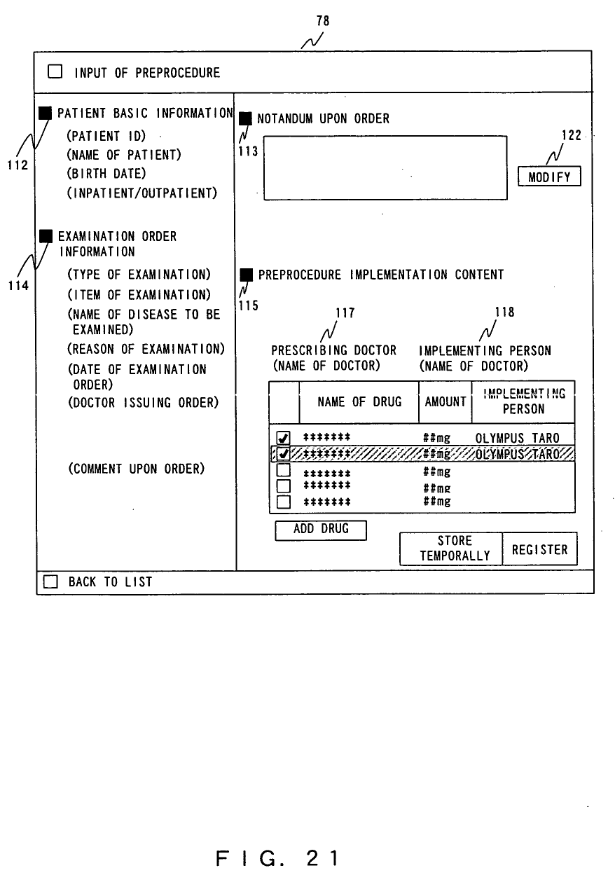

FIG. 21 shows an “Input of preprocedure” window 78.

In order to conduct input of a preprocedure, the “Input of preprocedure” window 78 is opened.

This “Input of preprocedure” window 78 can be referred to by both the reception terminal 2 and the input/examination terminal 3 (or a search terminal 4).

The “Input of preprocedure” window 78 mainly comprises a patient basic information display area 112, an examination order information display area 114, a notandum display area 113 for displaying allergy information, disease/notandum or the like, and a preprocedure implementation content display area 115 for input of the preprocedure information.

In the “Input of preprocedure” window 78, each datum regarding the preprocedures obtained from a preprocedure table 116 of the database 21 is displayed and also, the items (contents of medication) implemented as the preprocedures can be input. By obtaining and displaying, in a window, selection options of a drug master file 154 of the database 21 and selecting one of the selection options, the selected drug information can be registered in the preprocedure table 116. The input information in this window is later obtained from the preprocedure table 116 of the database 21 and transmitted to the HIS together with the examination implementation information in order to be available for accounting purposes.

When a doctor prescribes a preprocedure 117 and an implementing person 118 is input, so that the confirmation/input thereof is complete, the information can be registered in the database 21 by selecting the “Register” button 65. Also, the examination status managed in the examination table 65 is updated to the “preprocedure implemented” status.

Also, the received notandum (patient profile information) can be modified based on additionally found notandum (profile information) of a patient upon the implementation of the preprocedure or the like.

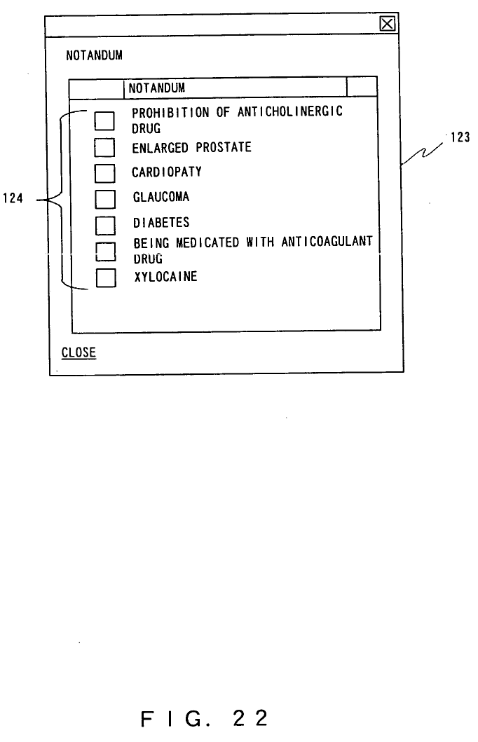

FIG. 22 shows a “Modification” window 123 for notandum (patient profile information).

When a “Modify” button 122 arranged in an upper portion of the “Input of preprocedure” window 78 is selected, the “Modification” window 123 for notandum (patient profile information) as shown in FIG. 22 is opened.

By checking checkboxes 124 for notandum arranged in the “Input of preprocedure” window 78, to toggle to the on state, or by canceling these checkboxes, to toggle to the off state, the information can be modified and registered. The modified information is registered in a notandum table 105 of the database 21 as the latest information. However, when deselecting checkboxes and a transition is caused to the off state, the user ID and the password are required so that they are verified against the staff master file 56 and recorded, the same requirement of ID and password verification is not performed when checking the checkbox and causing a transition into the on state. This extra verification is required in order to avoid the situation that an item of notandum which is important is not entered. More caution is needed for such modifications where items of information are deleted from the notandum than modification where items of information are added to the notandum.

<Step 4 (S4)>

Next, operations upon the photography as in step 4 in FIG. 18 will be explained.

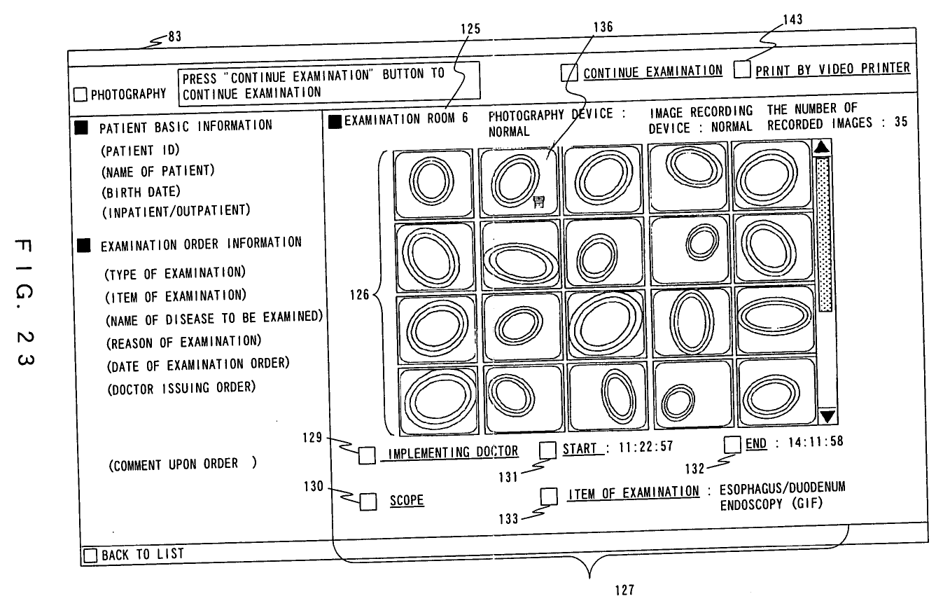

FIG. 23 shows a “Photography” window 83.

By opening the above “Photography” window 83, photography can be conducted. The “Photography” window 83 displays, in addition to the patient information and the examination order information which are displayed on the left of the window, examination room/examination device information 125, photographed image information 126, and an examination implementation information input area 127 on the right of the window.

When the “Photography” window 83 is displayed, patient information is transmitted to the input/examination terminal 3 installed in the examination room, so that the patient information is displayed on the electronic endoscope device 14 connected to the terminal 3.

Further, because the magnetic card reader 12 is connected to the input/examination terminal 3, it is also possible to insert a patients magnetic card into a card reader 12, for obtaining the patients basic information and the data corresponding to the patient basic information is thereby selected assigning automatic control to the input/examination terminal 3 itself.

When the transmission of the examination device patient information is completed as above, the examination is ready to be implemented, and photography can be started by selecting a “Photography” button 68.

On a photographed image display area 126, reduced images photographed for each release operation of the electronic endoscope device 14 are displayed in a sequentially arrangement.

When a release operation is conducted, the photographed image is firstly transmitted to the compressing/expanding device 13 so that the image is compressed. The compressed image is temporarily recorded in the memory of the compressing/expanding device 13 together with the patient basic information and forwarded to the server 5 via the LAN card. Even if the transmission of the images fails due to a network failure or the like, the photography can be continued without pause because the photographed images can be temporarily recorded in the memory of the compressing/expanding device 13.

Further, the images forwarded to the personal computer 8 of the input/examination terminal 3 are temporarily recorded on the hard disk 35, and also, are forwarded to the hard disk 24 of the server 5. As a result of this operation, even if the transmission of the images fails due to a damaged network cable or the like, the photography does not have to be suspended because the image data is recorded on the hard disk 35 of the input/examination terminal 3.

By expanding the compressed image 36 recorded on the hard disk 35, the above described reduced images 71 are displayed.

When the “Terminate examination” button on the electronic endoscope device 14 is selected, the photography operation is terminated so that the status information of the examination, managed in the examination management table 65 of the database 21 is updated to the “Terminated” status.

The above photography operation during the examination is controlled by the examination transaction DLL 29 of the main application software 27 on the input/examination terminal 3.

As for the photographed image, the pointer information thereof is registered in an image managing table 128, associated with the data of the examination in the examination table 65, and which identifies the storage location of the image.

In addition, to the above “Photography” window, characteristic and representative images can be selected, registered and attached to the report which will be described later. The name of the organ is attached to a reduced image of the selected and registered images, as denoted by numeral 136.

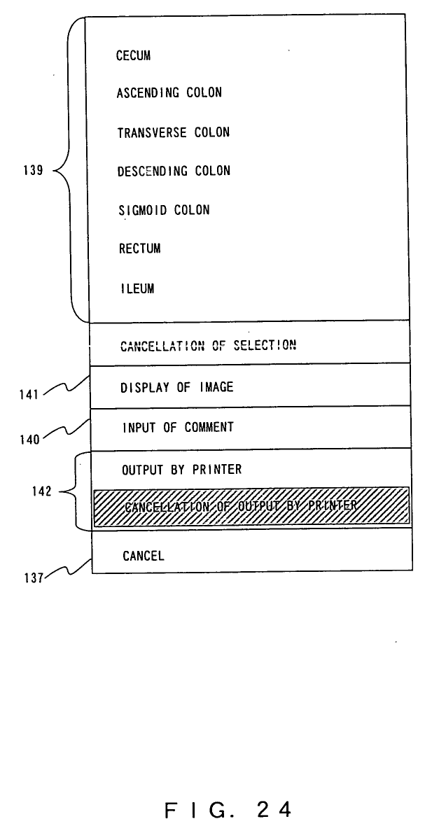

FIG. 24 shows the displayed contents of a “Selection” menu 137.

When an image to be selected is clicked on by selecting a mouse button, the “Selection” menu 137 of FIG. 24 is displayed by specifying organ 139, the name of the specified organ is displayed on the image. The numeral 136 denotes the state that “Stomach” is specified. organ name information specified during this operation is registered in a selected image table 138 of the database 21 together with an image number.

By registering the name of the organ corresponding to the selected image, the name of the organ (site) can be indicated when the image is referred to later. It is effective to register the name of the organ (site) at the time of photography especially in the cases of colonoscopies and bronchoscopies in which the characteristics of the photographed images are similar to one another. Further, in the calculation of insurance claim points, the number of points is determined according to the organ (site) on which the examination, the procedure or the operation is implemented so that the registered information can be efficiently utilized for an account transaction. In addition, the above information of the name of organ (site) is essential in the case that images are displayed as part of a report classified by organ (site).

Further, a comment can be input for each image. The comment can be input in a window for comment input opened by specifying “Input of comment” 140 on the “Selection” menu 137. Comments input by this operation are registered in an image information table 141 of the database 21.

Further, by selecting “Reduced image” and by specifying the “Display of image” 141 on the “Selection” menu 137, the full size original image can be displayed, or by specifying “Output to printer”/“Cancel output to printer” 142, the image can be output to a video printer.

When “Display of image” 141 is specified, the compressed image 22 on the server 5 is obtained and expanded so that the original image can be displayed. Also, when output to a video printer is specified, the image is registered in the selected image table of the database 21 so that the image selected to be output to the video printer can be printed by selecting a “Print to video printer” button 143 in the “Photography” window.

Next, operations upon the input of the implementation information specified in step 5 of FIG. 18 are explained.

<Step 5 (S5)>

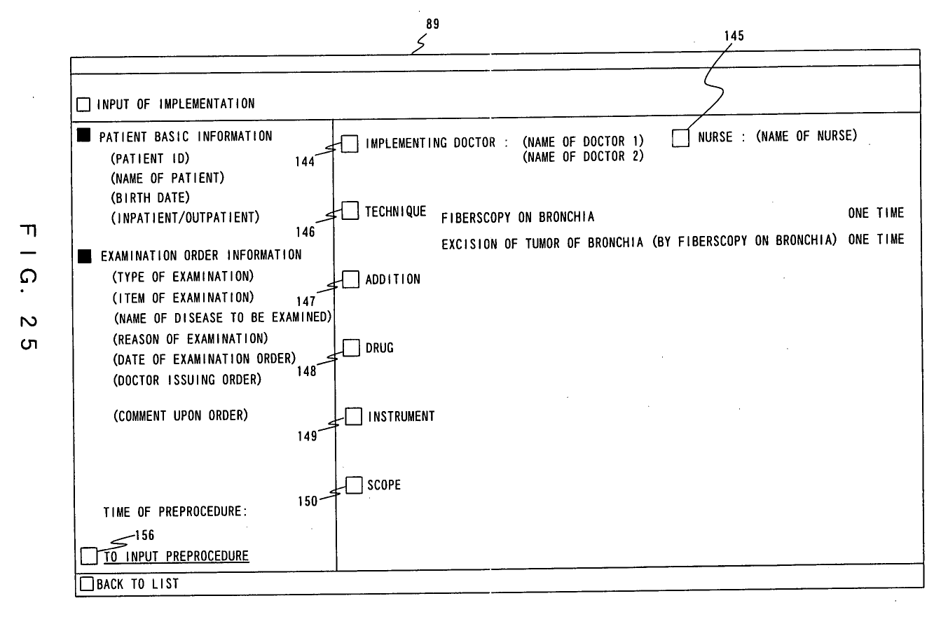

FIG. 25 shows the “Input of implementation” window 89.

By opening the above “Input of implementation” window 89, the implementation information can be input. In the above “Input of implementation” window, the details of the implementation of the examination (implementing doctor 144, nurse 145, technique 146, addition 147, drug 148, instrument 149 and scope 150) can be registered in the right portion of the window in addition to which, the patient information and the examination order information can be displayed on the left portion of the window.

When a button 156 for preprocedure input is selected, the “Input of preprocedure” window 78 can be opened.

By selecting buttons 144 to 150, the respective windows for information input listed below are opened so that the implementation information to be registered can be selected and input.

(1) Implementing Doctor

The selected implementing doctor information can be registered in the implementation table 134 by obtaining the selection options from the staff master file 56 of the database 21, displaying the selection options in a window, and by selecting the option.

However, when the implementing doctor information has already been registered on the “Photography” window 83, the registered information is displayed at the time when the “Input of implementation” window is opened. (Also, modification and registration of the information is possible in the “Input of implementation” window)

(2) Nurse

The selected nurse information can be registered in the implementation table 134 by obtaining the selection options from the staff master file 56 of the database 21, displaying the selection options in the window, and by selecting the option.

(3) Technique

The selected technique information can be registered in the implementation table 134 by obtaining the selection options from a technique master file 151 of the database 21, displaying the selection options in a window, and by selecting the option.

(4) Addition

The selected addition information can be registered in the implementation table 134 by obtaining the selection options from the addition master file 153 of the database 21, displaying the selection options in a window, and by selecting the option.

(5) Drugs

The selected drug information can be registered in the implementation table 134 by obtaining the selection options from a drug master file 154 of the database 21, displaying the selection options in a window, and by selecting the desired option.

However, when the drug information has already been registered on the “Input of preprocedure” window 78, the registered information is displayed at the time when the “Input of implementation” window is opened. (The modification and registration of the information are not possible in the “Input of implementation” window, thus it is possible to distinguish between drugs medicated upon the preprocedure and drugs medicated upon the implementation of the examination)

(6) Instrument

The selected instrument information can be registered in the implementation table 134 by obtaining the selection options from an instrument master file 152 of the database 21, displaying the selection options in a window, and by selecting the option.

(7) Scope

The selected scope information can be registered in an examination scope table 135 by obtaining the selection options from a scope master file 155 of the database 21, displaying the selection options in a window, and by selecting the desired option.

However, when the scope information has already been registered in the “Photography” window 83, the registered information is displayed at the time when the “Input of implementation” window is opened. (Also, the modification and registration of the information are possible in the “Input of implementation” window.) When the respective implementation information is selected, input and registered as above, the input of the implementation information is completed so that the examination status managed in the examination table 65 of the database 21 is updated to the “Implementation input completed” status.

Further, the input implementation information is transmitted to the HIS via a LAN together with the preprocedure information input in the “Input of preprocedure” window 78 by the GW 1. In the HIS, it is possible that an account transaction is conducted based on the above preprocedure information and the examination implementation information, and the calculation of the insurance claim points or the like is conducted.

Next, operations upon the input of a report as specified in step 6 of FIG. 18 are explained.

<Step 6 (S6)>

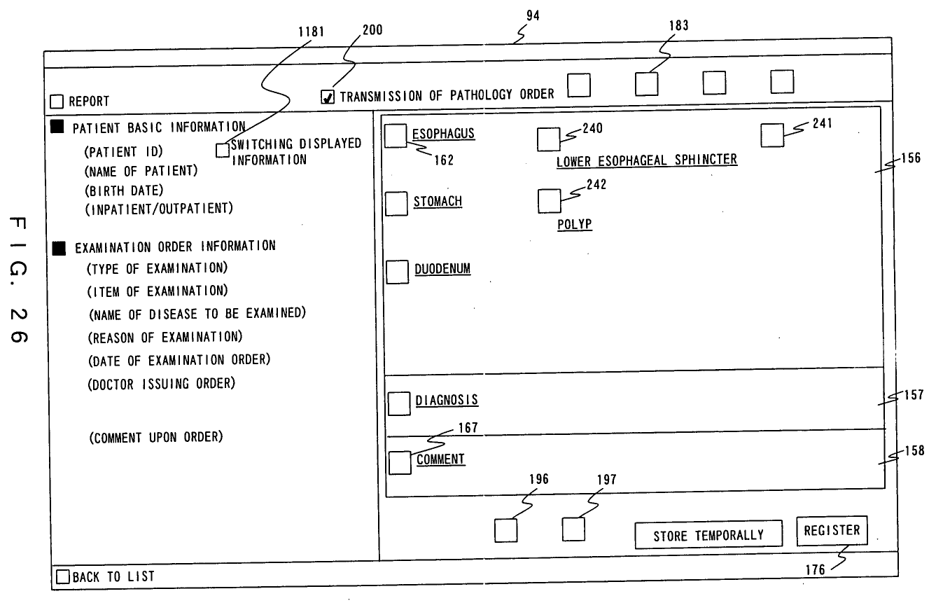

FIG. 26 shows the “Input of report” window 94.

A report can be input by opening the above described “Input of report” window 94 as shown in FIG. 26. In the “Input of report” window 94, the contents of the examination report (remarks and procedure 156, diagnosis 157, comment 158) can be registered in the right portion of the window. In addition to that the patient information and the examination order information are displayed in the left portion of the window in the same manner as the other respective windows.

(1) Remarks and Procedure

The selected terms of remarks and procedure can be registered in an implementation table, remarks term information table 160 and a procedure term information table 161 by obtaining the selection options from a term master file 159 of the database 21, displaying the selection options in a window, and by selecting the option.

(2) Diagnosis

The selected diagnosis term information can be registered in a diagnosis term information table 162 by obtaining the selection options from a term master file 159 of the database 21, displaying the selection options in a window, and by selecting the option.

The operations of the window displaying the remarks and procedure, and the window displaying the contents of diagnosis as selection options are common to each other.

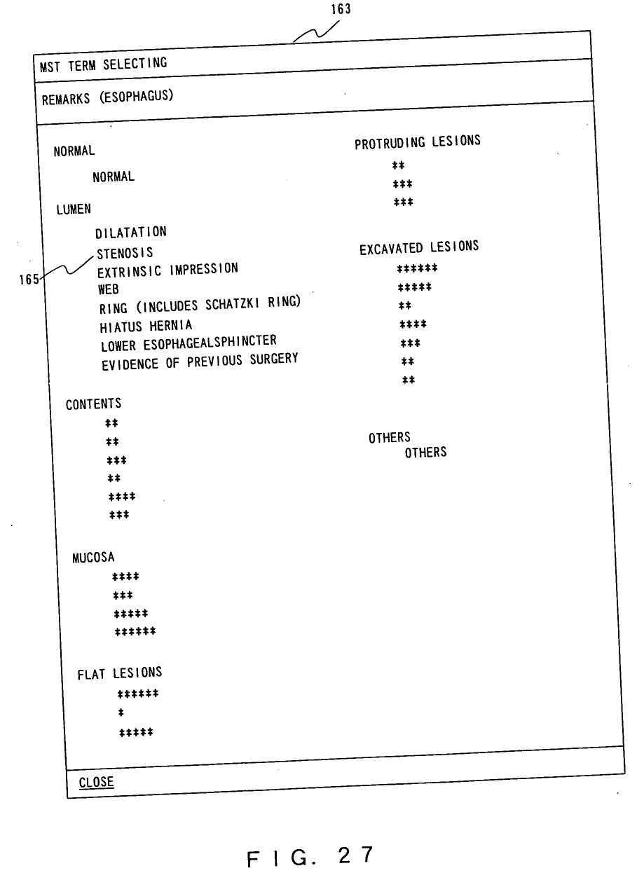

FIG. 27 shows an example of input of remarks.

A “Term” window 163 shown in FIG. 27 is a display example used for esophagus (the terms used are based on MST, minimal standard terminology, for endoscopy) and is opened when the “Esophagus” button 162 on the “Input of report” window 94 is selected.

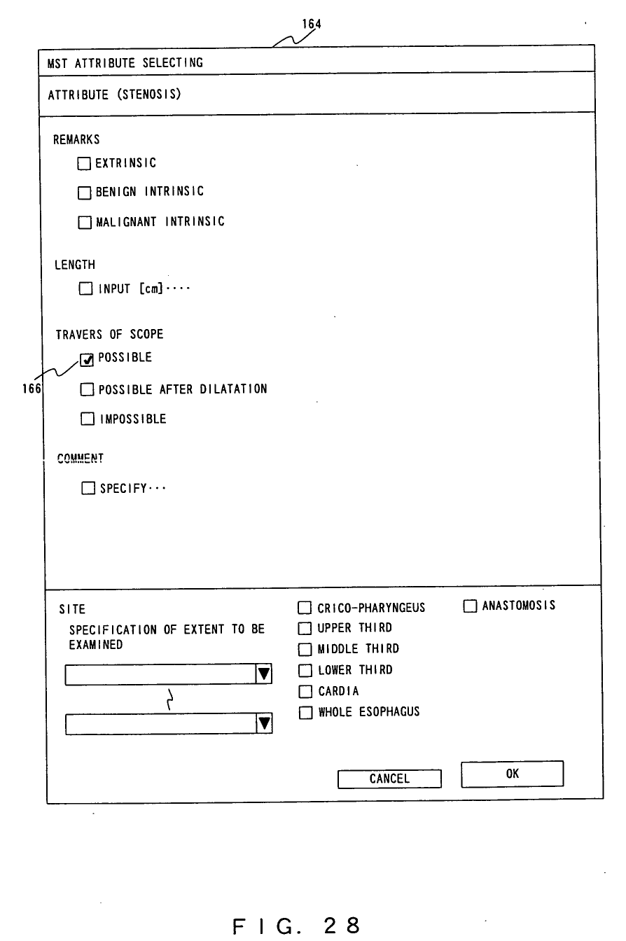

FIG. 28 shows a “Term” window 164.

The “Term” window 164 shown in FIG. 28 is a window which is opened when “Stenosis” 165 as one of terms to be selected in the window 163 is selected. For example, when the following contents of (organ)—(group of terms)—(terms of remarks)—(title of attribute)—(attribute value)—esophagus—lumen—stenosis—traverse of scope—possible Are to be input in accordance with the hierarchy of MST, the processes in the window are conducted as below.
Process 1: when the “Esophagus” button 162 is selected, the window 163 is opened
Process 2: when “Stenosis” 165 is selected on the window 163, the window 164 is opened
Process 3: check a checkbox “Possible” 166 is selected and changes to the on state of “traverse of scope” in the window 164

Because two classes of the hierarchy are simultaneously displayed in one window as above, the selection can be completed in three processes. This selection required five processes on a conventional system in which a tree is selected for input in accordance with the hierarchy.

Also, although the input may be conducted for each organ (site), a menu “Normal in every aspect” can be prepared for the case that every organ (site) is in a normal condition. In this case, “Normal” can be input with respect to every organ (site) by a single menu selection.

(3) Comment

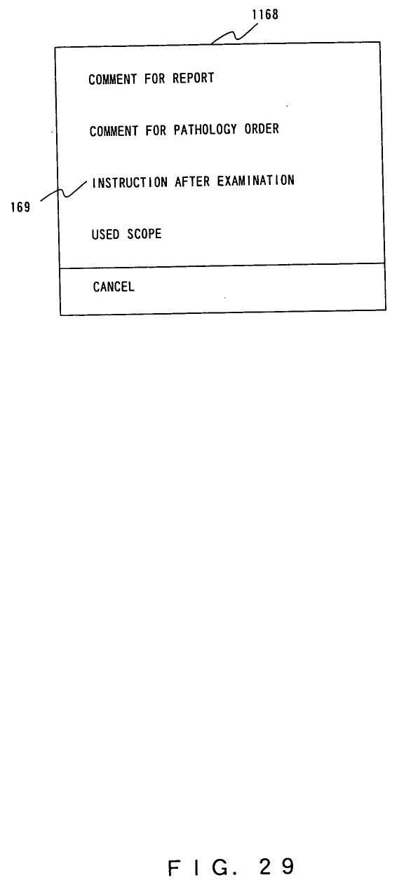

FIG. 29 shows a “Comment” menu 1168.

When the “Comment” button 167 is selected, the “Comment” menu 1168 as shown in FIG. 29 is displayed for determining the kind of comment to be input and each comment can be input by selecting the options of the “Comment” menu 1168 and opening a window for input of text information. The input comment information is registered in a lesion table 168 of the database 21.

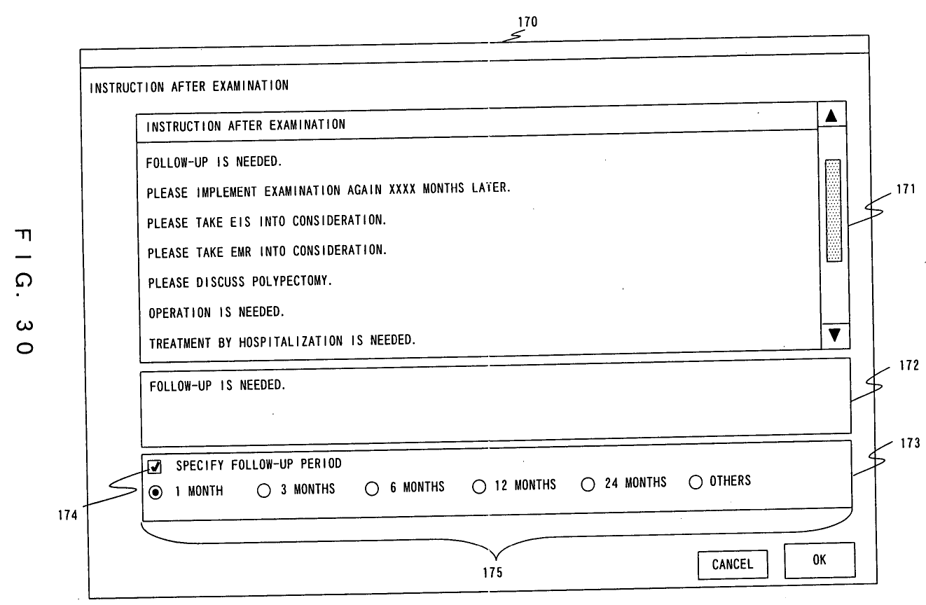

FIG. 30 shows an example when an “Instruction after examination” 169 is specified.

On a “Selection option” area 171 of a “Selection option” window 170, fixed sentences read out from the term master file 159 of the database 21 are displayed and by selecting a fixed sentence, the selected fixed sentence is set in a “text information input” area 172. The information in the “text information input” area 172 can be edited in a free text format.

In addition, in the “Selection option” window 170, “Follow-up period specification (scheduled date of next examination)” area 173 is arranged so that a date for a scheduled follow-up 175 can be selected/input by checking checkboxes 174.

Upon the above operation, the input instruction after examination information and the input follow-up period information are registered in the lesion table 168 of the database 21.

Special care is taken to ensure that the follow-up period information is input by the selection shown in FIG. 30 and registered so that a search can be conducted later in order to display a list of patients requiring follow-up.

In addition, each of the report information (1) to (3) can be input while referring to the photographed/recorded images.

If the “Switch displayed information” button 1181 in the left upper portion of the “Input of report” window 94 (FIG. 26) is selected, images selected to be attached to the report can be displayed instead of the patient information and the examination order information which are displayed in the area of the left portion of the window.

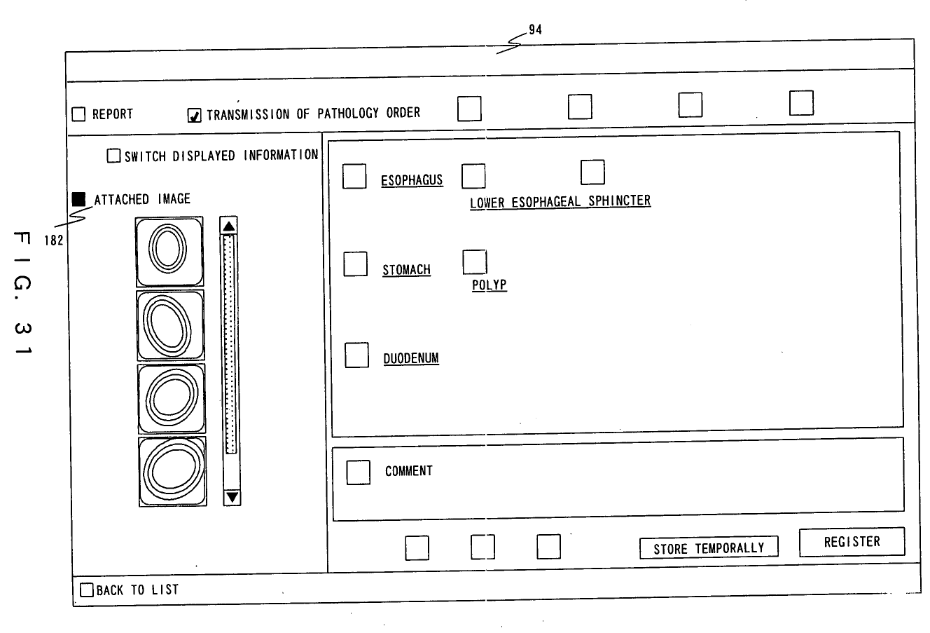

FIG. 31 shows a state where the display is switched by selecting the “Switch displayed information” button 1181 (FIG. 26).

The pointer information of the image selected to be attached to the report in the “Photography” window 83 is managed by the selected image table 138 of the database 21 so that images attached to report 182 can be displayed by referring to the above pointer information in the table 138. Because the above images attached to the report can be displayed without being superimposed on the input area for the report information, the report information can be input while referring to the images.

(4) Schema

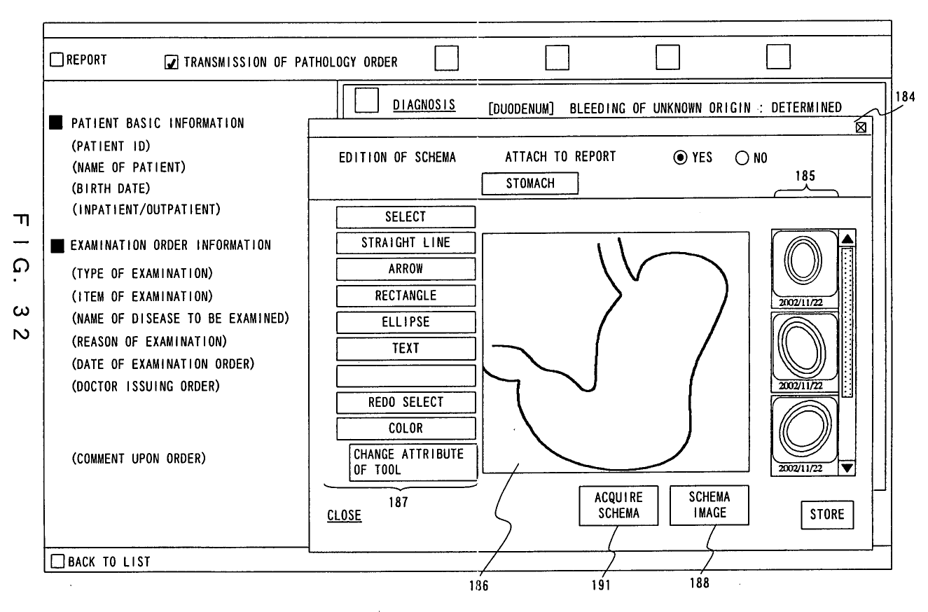

FIG. 32 shows an opened state of an “Edit image schema” window 184.

By selecting a “Select schema” button 183 in the upper portion of the “Input of report” window 94, the “Edit schema image” window 184 can be opened. The “Edit schema image” window 184 mainly comprises images attached to a report display area 185, a schema display area 186 and buttons for editing 187. The kinds of schema to be displayed in the schema display area can be selected by selecting the options presented by selecting the “Schema image” button 188.

The selected kinds of schema are registered in the selected schema table 189 of the data base 21. In addition, the selected schema can be edited with “Straight line”, “Arrow”, “Rectangle”, “Ellipse”, “Text” and the like, selected as tools for editing by selecting the buttons for editing 187. The edited content based on the schema is managed independently from the schema and registered in an edited schema table 190 of the database 21.

Further, by selecting an “Acquire schema” button 191, the external images can be acquired as schemas by specifying offline external media such as a flexible disk (registered trademark), an MO disk or the like.

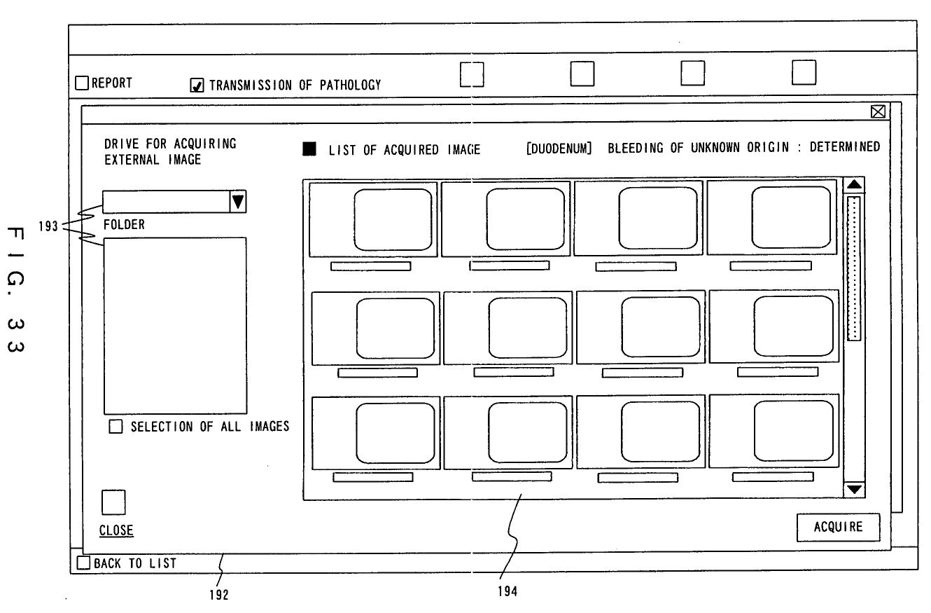

FIG. 33 shows an opened state of an “Acquisition of external image” window 192 when the “Acquire schema” button 191 is selected.

By selecting an acquisition source on a checkbox for specifying a drive or a folder from which the external image is acquired, a list of images 194 stored in the specified acquisition source is displayed so that the acquisition can be conducted by selecting images to be acquired as schemas from the list. The acquired image is stored on the hard disk 24 of the server 5 and the pointer information thereof is registered in the selected image table 195 of the database 21. When the acquisition is completed as above, an “External image” icon 196 is displayed on the lower portion of the “Input of report” window 94. When the icon 196 is selected, the acquired images are displayed in order to be referred to.

The registration of input report information can be completed by selecting the “Register” button 176 arranged on the right upper portion of the “Input of report” window 94 after completing the input of the report information.

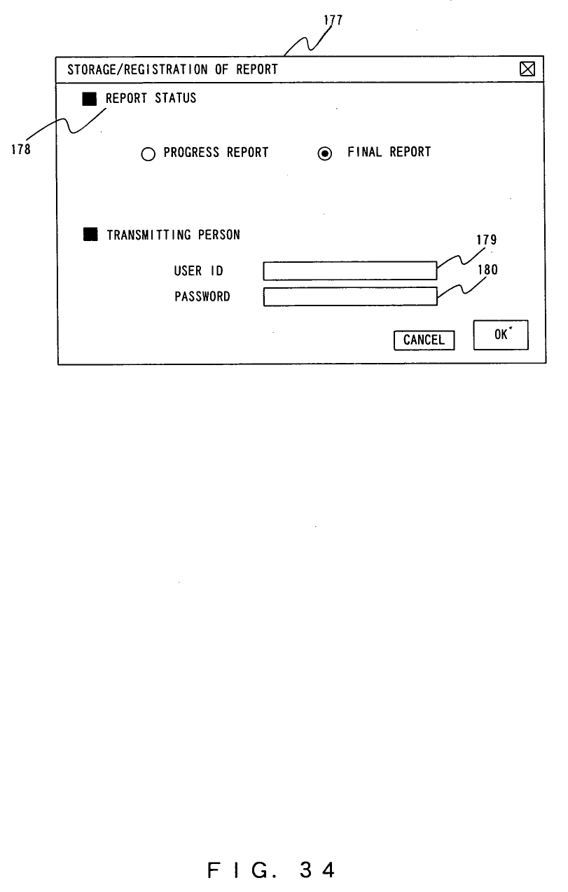

FIG. 34 shows a “Verification” window 177.

When the “Register” button 176 is selected, the “Verification” window 177 as shown in FIG. 34 is displayed in order to verify the input user ID and the password 179 of the transmitting person. The verification is conducted by confirming that the user ID and password pair of a user registered in the staff master file 56 of the database 21 correspond to the input information.

Further, on the “Verification” window 177, radio buttons are arranged for selecting the “Report status” 178. The report is registered as a progress report or a final report by selecting the “Progress report” or the “Final report” status.

Further, the report once registered can not be overwritten, so that versions are managed by recording a 1^{st} version, a 2^{nd} version, a 3^{rd} version, and so on, of the progress report, and a 1^{st} version, a 2^{nd} version, a 3^{rd} version, and so on, of the final report (the history of reports is managed).

Each pointer information associated with each report information in a report management table 181 of the database 21 is managed so that the reports can be prepared utilizing the pointer information, and further, the above described report status and the versions are managed in the above report management table 181 making it possible that the history of a report can be managed without overwriting reports.

<Step 7 (S7)>

As above, the transmitted report information can be referred to in a system of the endoscopy department and also, is transmitted to the HIS via LAN by the GW 1 so that the report information can be referred to in an electronic medical record system of the HIS.

Further, upon the registration and the transmission of a report, a pathology order can be issued based on the report information (step 10 (S10)). When a pathology order is issued, the information relating to the pathology order is registered in a pathology order management table 198 of the database 21 and an image attached to the pathology order is registered in the pathology image table 199. Further, an icon 197 indicating that a pathology order has been issued is displayed in a lower portion of the “Report” window 94.

Also, it is not uniquely determined whether or not a pathology order has to be re-transmitted, in case the version of a report is updated when the report is registered and re-transmitted again.

Therefore, a checkbox 200 determining whether or not the pathology order is transmitted upon the update of report is displayed in the upper portion of the “Input of report” window so that the pathology order is issued upon the update of report only when the above checkbox 200 is checked (toggled to the on state).

Next, methods of reference and edit management of the recorded/stored image information and report information are explained.

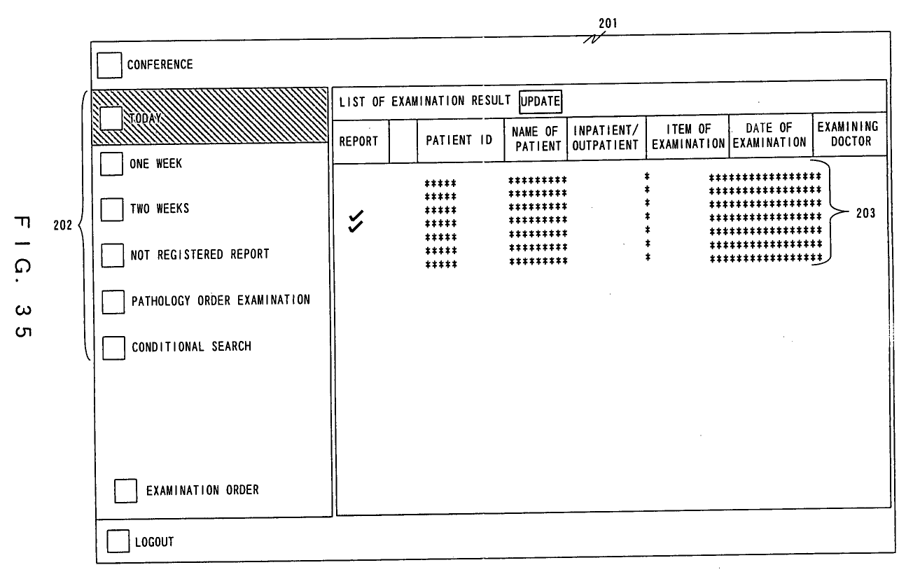

FIG. 35 shows a “Conference” window 201 opened upon login by selecting the “Conference” icon 53 on the “Activation/termination of system” window 101.

On the left portion of the window, a group of search buttons 202 for searching for examinations are arranged so that when these icons are selected, the database 21 is searched based on a prescribed condition and the search result is displayed as a “List of examination results” 203.

The group of search buttons 202 includes buttons such as “Today”, “One week”, “Two weeks”, “Not registered report”, “Pathology order examination”, “Conditional search” and the like. When the “One week” button is selected, for example, a list of examinations implemented in the past week is displayed, and when the “Conditional search” button is selected, for example, a list of examinations that are the result corresponding to a conditional search in accordance with the input conditions is displayed as the “List of examination results” 203.

When one of the items displayed in the above “List of examination results” 203 is selected, a menu is displayed for selecting “Display of image” or “Display of report” so that by selecting one of the above two options, the window for displaying the image/report is opened.

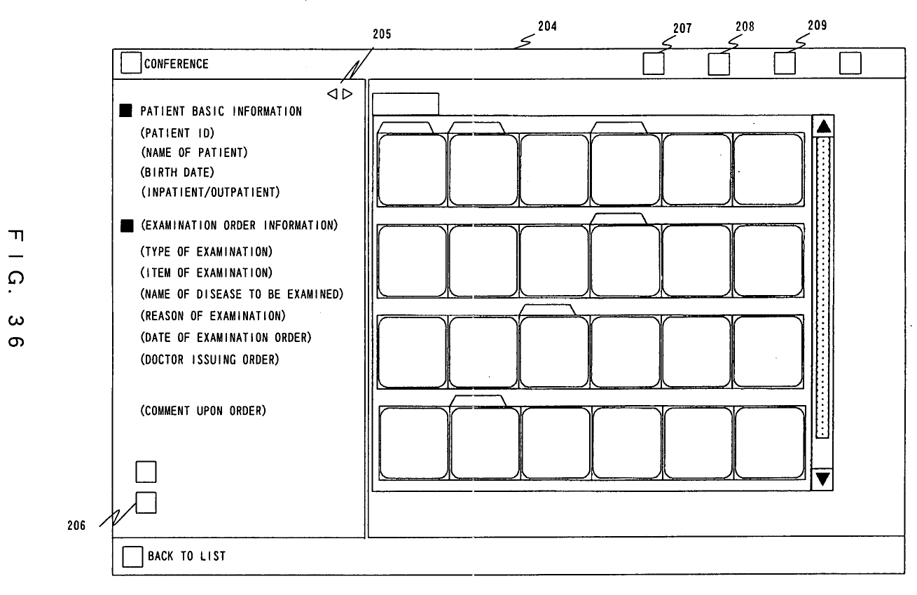

FIG. 36 shows a “Display of image” window 204 opened by selecting the “Display of image” from the above menu.

The layout of the above window is similar to the “Photography” window, however, the window is differs in that the function for input of the examination implementation information (implementing doctor, used scope, start time/end time of photography and the like) is not provided.

Also, a conference function is added so that images of a previous/next examination in the “List of examination results” 203 can be displayed by selecting the “Another patient” button 205.

Further, a function for storing copies of the selected images on a flexible disk or an MO disk is available, so that a window for specifying the destination device, the file format and the like is opened by selecting the “Copy images” button 206 after selecting the images.

In addition, upon copying the images, the user ID and the password are verified so that security is maintained regarding the removal of data (images) in a similar way to the window of FIG. 34, however, the window for this function does not comprise the input area for a report status.

On the upper portion of the window, “Display report” 207, “Display images in comparison” 208 and “Display simultaneously with past examination” 209 buttons are arranged so that the layout of the window can be changed in the following ways by selecting the respective buttons.

(1) When the “Display report” button 207 is selected, the “Input of report” window 94 is opened. (If it is necessary that the examination result (report) information be edited during a conference conducted among a plurality of doctors, the updated information can be input. In this case, the edited information is under version management so that the updated information is managed with a different version number from the information before the update).

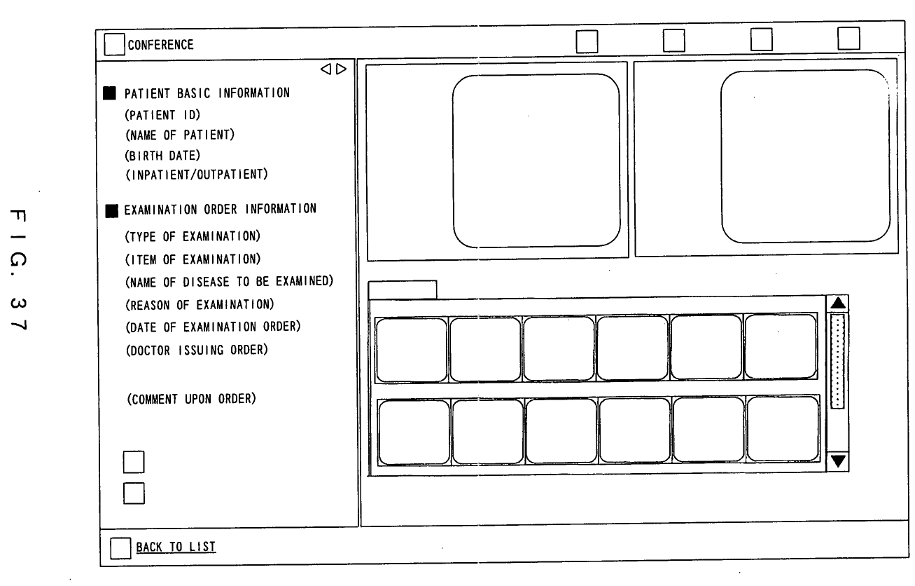

FIG. 37 shows an example of the layout when the “Display images in comparison” button 208 is selected.

(2) When the “Display images in comparison” button 208 is selected, the layout of the window changes to the layout as shown in FIG. 37 so that the images can be displayed in a compared state thereof.

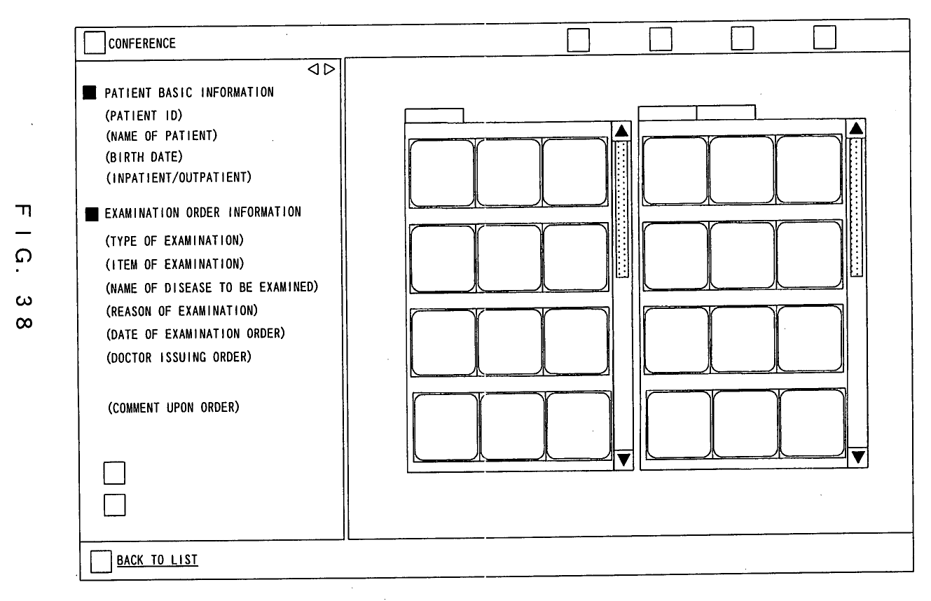

FIG. 38 shows an example of the layout when the “Display simultaneously with past examination” button 209 is selected.

(3) When the “Display simultaneously with past examination” button 209 is selected, the layout of the window changes to the layout as shown in FIG. 38, so that a group of images of past examinations implemented for the same patient can be simultaneously displayed.

The control of the above operation is conducted by the conference DLL 30 of the main application software 27 on the search terminal 4 (or on an input/examination terminal 3). The displayed information is read out from the database 21 and the various data being edited and input are registered in the database 21. In addition, this edited information is forwarded to the HIS by the reception transaction application software 20 on the reception GW 1.

Next, the function of scope history which is a representative function of the statistics/history functions is explained.

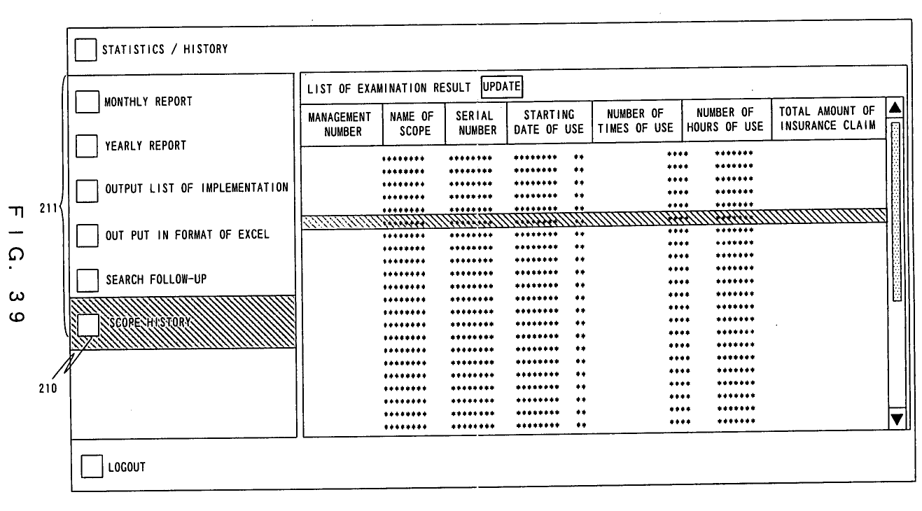

FIG. 39 shows a “Statistics/history” window opened upon login by selecting the “Statistics/history” icon 54 on an “Activation/termination of system” window 101.

In the left portion of the window, a group of icons for selecting respective statistics/history functions 211 is prepared so that a function for output of the monthly report/yearly report/list of implementation (daily report), a function to export data in EXCEL format, a function to search follow-up period (scheduled date of examination) of the above described patient requiring follow-up and a function of displaying the scope history are available.

FIG. 39 shows the window in a state where a “Scope history” icon 210 is selected among the group of icons on the left portion of the window.

When the “Scope history” icon 210 is selected, a list of “Management number”, “Serial number”, “Start date of use”, “the number of uses”, “the number of hours of use” and “total amount of the insurance claim” (reference value) together with the “Name of scope” are displayed on the right portion of the window. The above displayed items are the information read out from the examination scope table 135 and the scope master file 155 of the database 21.

Because the scope used for the examination is registered in the “Photography” window 83 or the “Input of implementation” window 89, the start/end time of the examination is registered in the “Photography” window 83 and further, the technique information of the implemented examination is registered in the “Input of implementation” window 89, the “Start of use date”, “The number of uses”, “The number of hours of use” and “Total insurance claim amount” of each scope can be calculated (insurance claim points for each technique are registered in the technique master file 151).

Next, a function of contrast and incorporate of order which is a representative function of the management functions is explained.

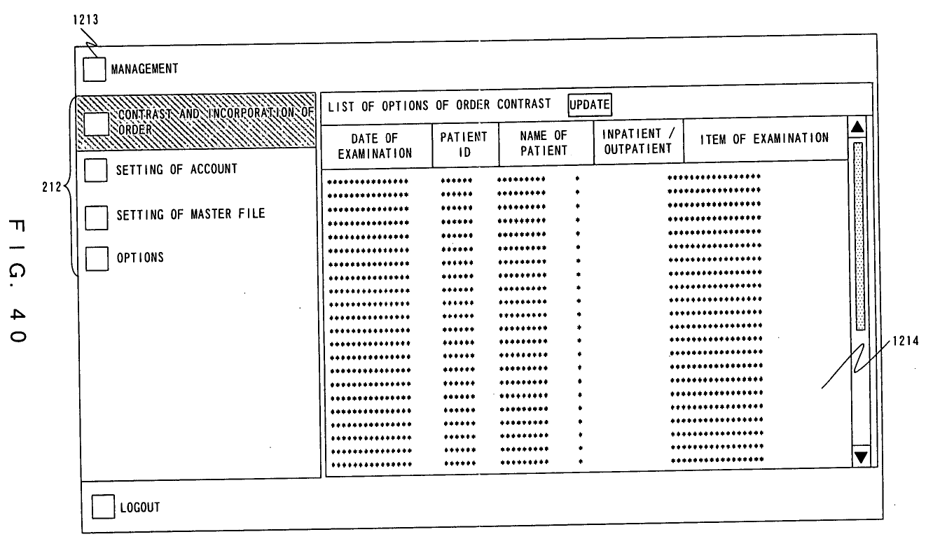

FIG. 40 shows a “Management function” window opened upon login by selecting the “Management function” icon 55 in an “Activation/termination of system” window 101.

In the left portion of the window, a group of icons for selecting respective management functions 212 is displayed so that the function of contrast and incorporate of order, a function for configuring accounts, a function of setting master files and the function of options are available.

With the function of configuring accounts, user accounts of the present system can be registered, modified and deleted, and the user level and authority can be modified. Also, with the function for configuring accounts, the contents of the staff master file 56 of the database 21 can be accessed.

With the function for configuring the master files, the registration, modification, and the deletion of the type of examination, item of examination, technique, addition, drug, instrument and the like can be conducted in the respective master files. And further, using the master file configuration function, the contents of a type of examination master file 213, an item of an examination master file 214, a technique master file 151, an addition master file 153, a drug master file 154, an instrument master file 152, a notandum master file 215, a scope master file 155 and a term master file 159 can be accessed.

With the options function, an arbitrary application can be set in advance and by selecting an icon corresponding to the set application, the application can be activated.

FIG. 40 shows the window in a state where a “Contrast and incorporate of order” icon 1213 has been selected among the group of icons in the left portion of the window.

When the “Contrast and incorporate of order” icon 1213 is selected, a list of the in-department orders issued on the previously described “Registration of in-department order” window 1101 and image-only examinations which were started at the observation device 14 without any order is displayed in the right portion of the window. The display of the above information is realized by referring to the status information of the examination, managed in the examination table 65 of the database 21.

The in-department order is used for issuing examination orders within a department system when the order information from the HIS is unavailable, and the in-department order can be incorporated with the normal orders from the HIS by contrasting them after receiving a normal order from the HIS. Specifically, the contrasting of orders can be conducted by associating, with the normal orders, various link data which is associated with the in-department orders, and which exists in tables other than the order information table 57. A similar process can be applied to the contrast between the image-only examinations and the order, and to the incorporation of the image-only examinations to another order.

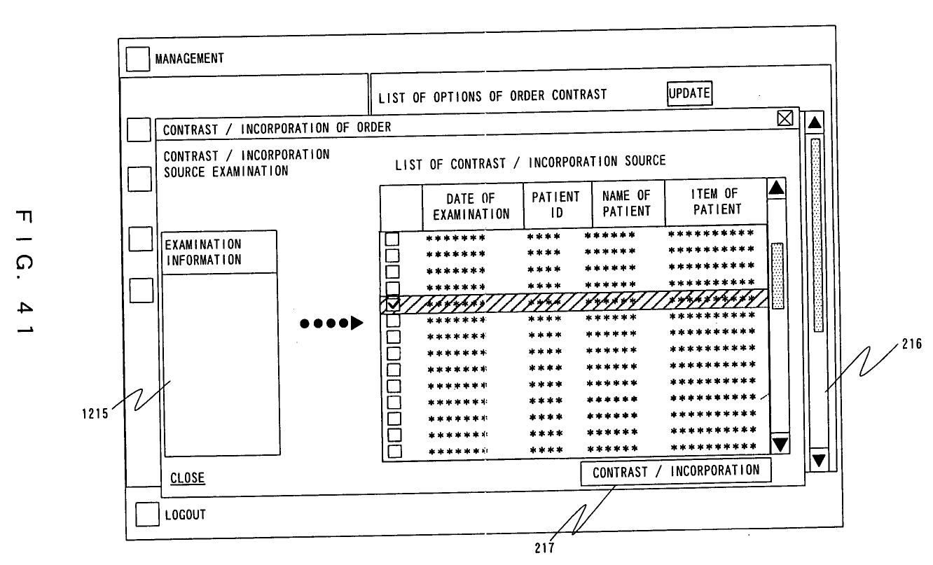

FIG. 41 shows a “Contrast and incorporate of order” window opened by selecting the examination from the list 1214 in FIG. 40, which the contrast and incorporate operation is to be conducted on.

In the left portion of the window, examination information 1215 of the selected examination of which contrast and incorporate information is wanted is displayed, and on the right portion of the window, a “List of contrast and incorporate options” 216 is displayed. On this window, by selecting a “Contrast and incorporate” button 217, after selecting one of the examinations on which the contrast and incorporate is conducted in order to check the corresponding checkbox (toggle to the on state), the contrast and incorporate is completed (link information of various tables associated with the examinations before the contrast and incorporate is associated with the order to which the contrast and incorporate is conducted).

As above, in the first embodiment of the present invention, the selection and the input of the organ (site) upon the selection of the image on the “Photography” window can be conducted so that the name of the organ (site) can be input upon the photography or immediately after the photography. Thereby, more precise and efficient data input can be realized.

Further, by using the organ (site) data, input in the “Photography” window, an automatic input (display) of the implementation information is conducted so that more precise and efficient input of implementation information and account processing can be realized.

Further, by using the information of the organ (site) input in the “Photography” window, the images can be displayed respectively for each organ (site) in the “Input of report” window so that a more precise and efficient input of report can be realized.

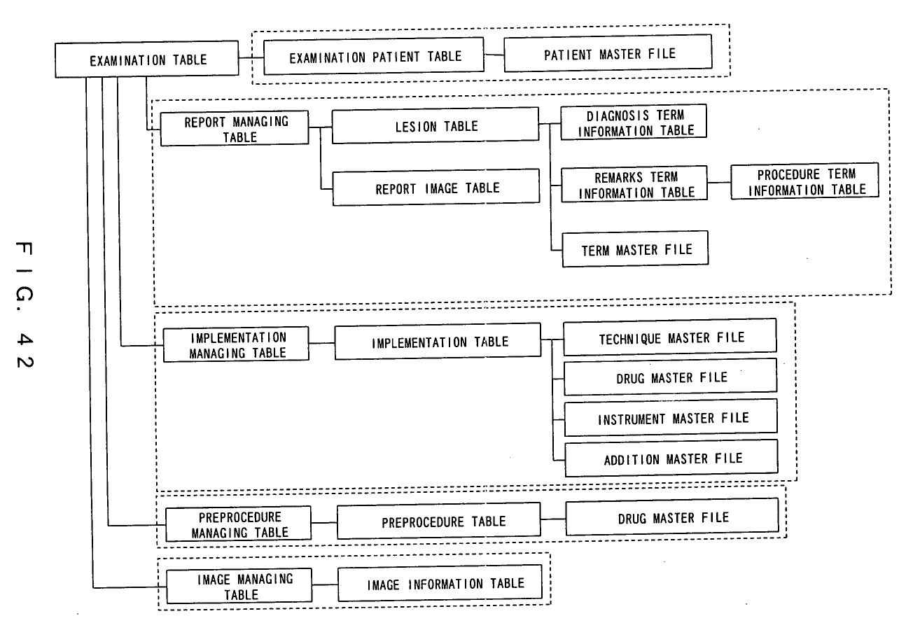

Next, second to fourth embodiments are explained referring to FIG. 42 to FIG. 63.

The second embodiment to the forth embodiment are the same as the above first embodiment except for the points which are explained below.

First, the second embodiment is explained by referring to FIG. 42 to FIG. 52.

The hardware configuration of an endoscope examination management system according to the second embodiment of the present invention is the same as that of the first embodiment shown in FIG. 1. Specifically, the endoscope examination management system of the second embodiment comprises the GW 1 (gateway) for exchanging data with other departments in a hospital, the input/examination terminal 3 for conducting examinations, the search terminal 4 for the input of and display of graphical data and various kinds of information, and the server 5 for recording data. The above respective devices are connected to one another via the network (LAN) distributed by the HUB 7.

The software configuration of the endoscope examination management system according to the second embodiment of the present invention is the same as that of the first embodiment explained by referring to FIG. 2. Specifically, on the hard disk of each device, various application software, databases and the like are installed in order to be operated thereon.

In the search terminal 4, the examination transaction DLL (dynamic link library) 29, the conference DLL 30, the statistics/history DLL 31 and the management function DLL 28 are called and activated by the main application software 27. In the server 5, the database 21 of the examination information, a file for the report information 23 for the examination and a file for the compressed image 22 are recorded and managed.

FIG. 42 shows a configuration of the table/master files of examination tables according to the second embodiment.

The patient master file, an implementation management table for managing the implementation information and the report management table for managing the report information are associated with the examination table as the core of the information of the examination.

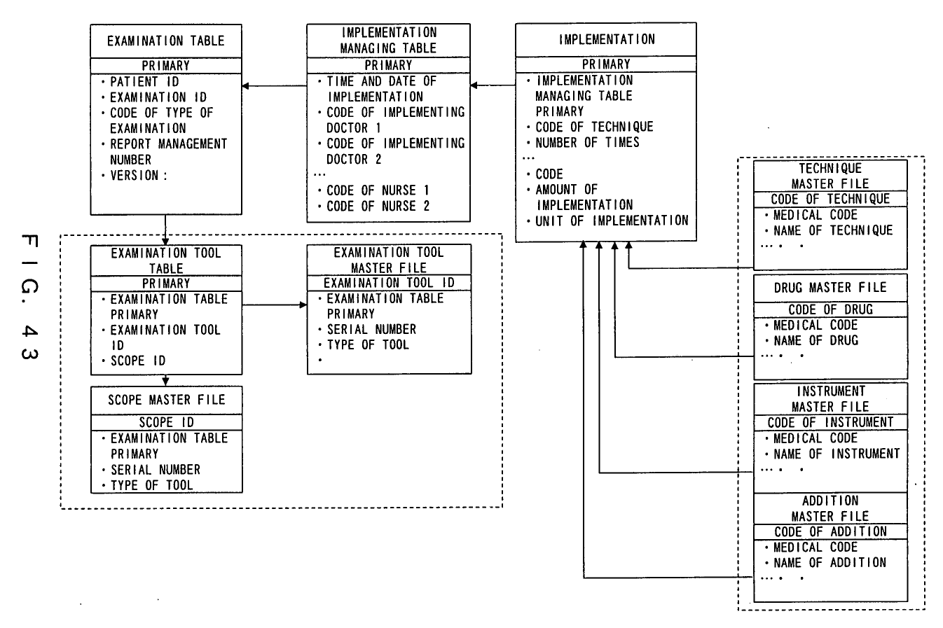

FIG. 43 shows data stored in the implementation management table according to the second embodiment.

The examination table comprises the implementation management table for managing the time and date of implementation, the implementing doctor and the nurse, the implementation table for managing the implemented technique, the drug used, the instrument, the addition code and amount/unit of implementation, and the technique master file for managing the code/name of the technique, the drug master file for managing the code/name of the drug, the instrument master file for managing the code/name of the instrument, the addition master file for managing the code/name of the addition.

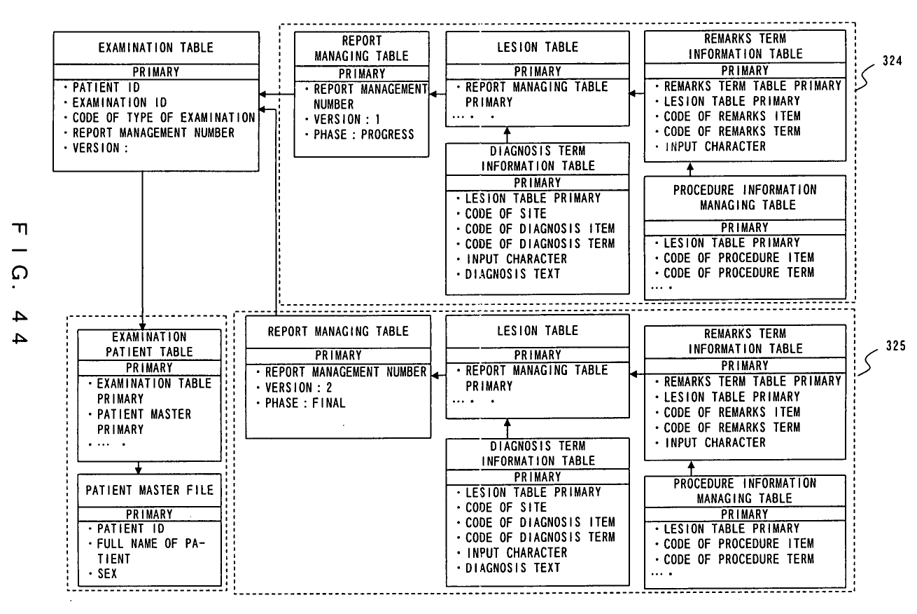

FIG. 44 shows tables for managing the report information according to the second embodiment.

A progress report 324 and a final report 325 are managed in units of version number or of phase, and are configured in association with a lesion table, a remarks information table, a diagnosis information table and a procedure information management table.

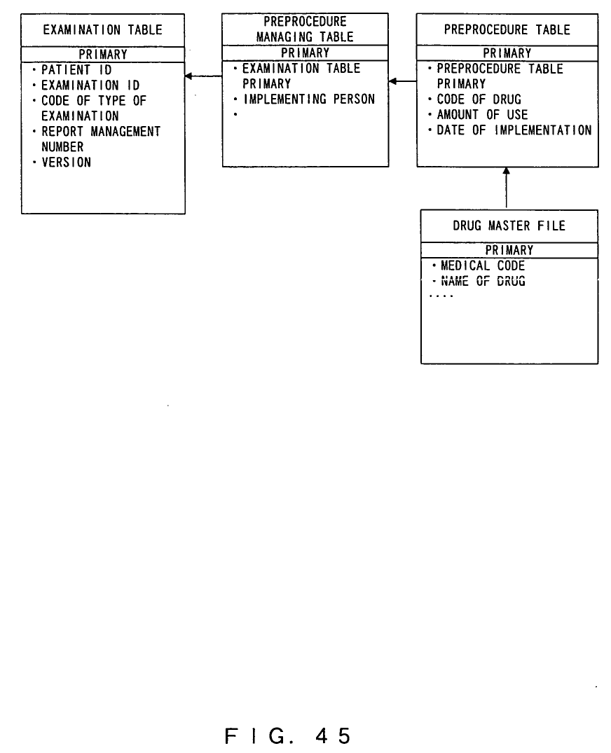

FIG. 45 shows tables for managing preprocedures according to the second embodiment of the present invention.

The above tables are configured for management in association with the drug master file.

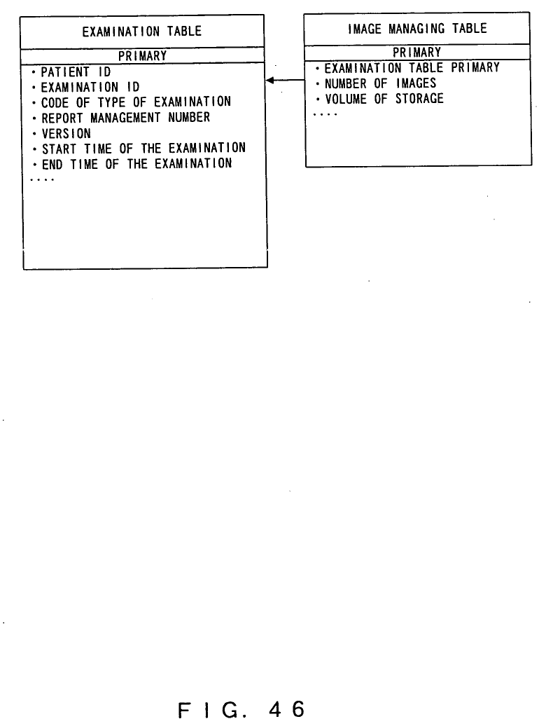

FIG. 46 shows tables for managing the image information according to the second embodiment of the present invention.

The above tables are configured to manage image information such as the storage place of the images, the number of the images and the like.

Next, the transaction flow of the examination during an endoscope examination by the management system and according to the present invention is explained.

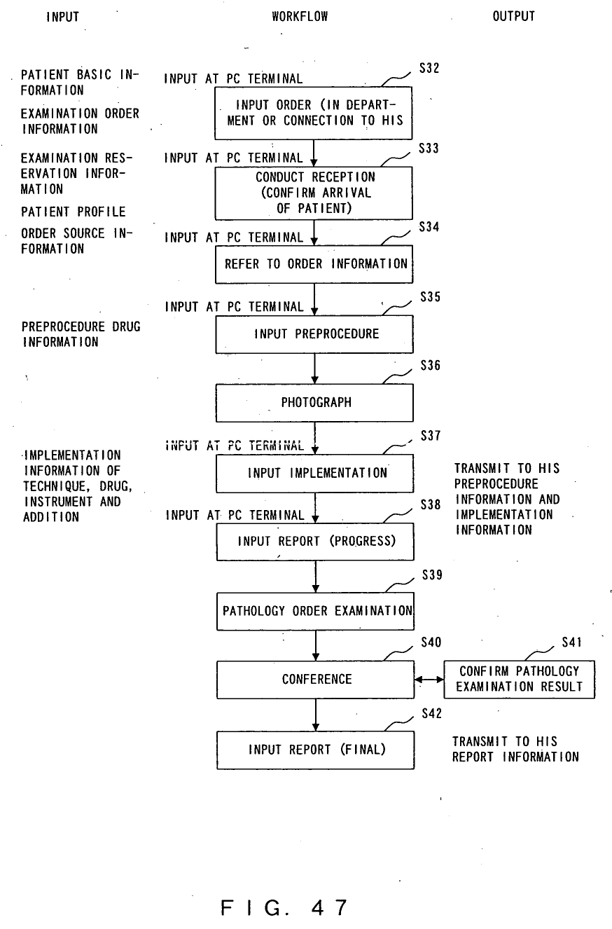

FIG. 47 shows the transaction flow of an endoscope examination.

Firstly, upon the input of an order in step S32, the order information, such as the patient information and the examination order information are input before the examination.

Upon executing step S33, the confirmation of the patient's arrival is conducted.

Upon reference to the order information of step S34, the order information which was input or transmitted beforehand is confirmed in a window.

Information indicating that the injection of the drug to be used before photography was implemented as a preprocedures is input at step S34.

Upon step S36, the photography of endoscopic images is implemented using the endoscope device 14.

Upon the input of implementation in step S37, the information necessary for the account information such as the implemented technique, drug, instrument and addition is input. The input information is transmitted to the HIS as implementation information.

Upon the input of the report of step S38, a doctor who has implemented the photography of the endoscopic images inputs the progress report.

Upon the pathology examination order of step S39, tissues which are thought to include lesions are extracted so that an order for tissue diagnosis is issued to the pathology department.

Upon the conference of step S40, doctors gather and an analysis of the medical case is undertaken. During the conference, the results of the pathology are confirmed by reference to the pathology examination results of step S41.

Instep S42, a doctor inputs the final report based on the result of the above conference.

Operations according to the second embodiment of the present invention are explained.

The photographed image is recorded from the electronic endoscope device. The method of input in a window of the search terminal is the same as that of the previously described first embodiment.

Firstly, when the management system according to the present invention is activated, an “Examination transaction” window, a “Conference” window, a “Statistics” window and a “Management” window are opened, and a list of examination orders are displayed in the “Examination transaction” main window. In the “Photography” window, the original image of the examination image and the index image can be displayed, and the selection of the image to be attached to the report and the input/display of the name of an organ can be conducted.

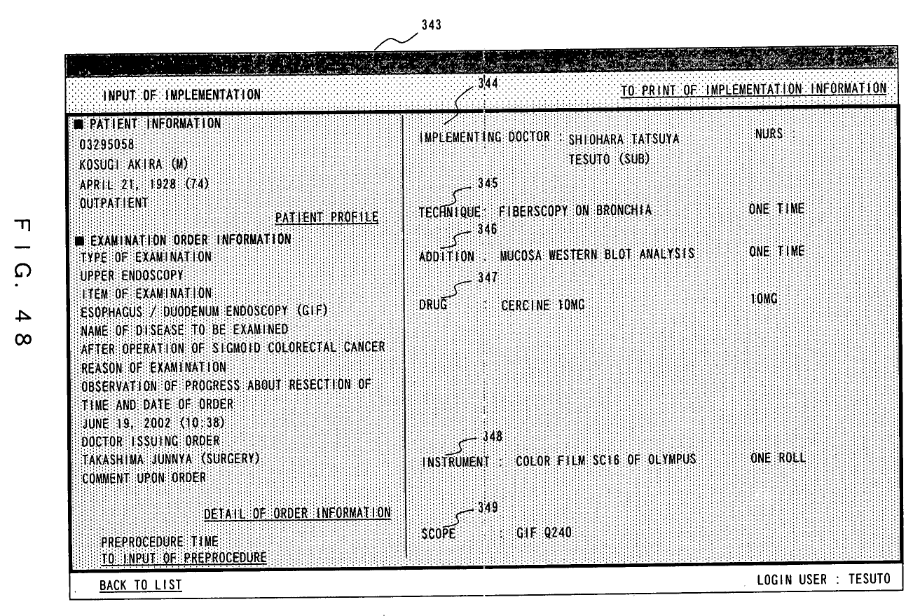

FIG. 48 shows an example of the “Input of implementation” window for the input of implementation information in step S37 of FIG. 47.

As shown in FIG. 48, data regarding implementing doctor 344, technique 345, addition 346, drug 347, instrument 348 and scope information 349 respectively are input in the “Input of implementation” window 343.

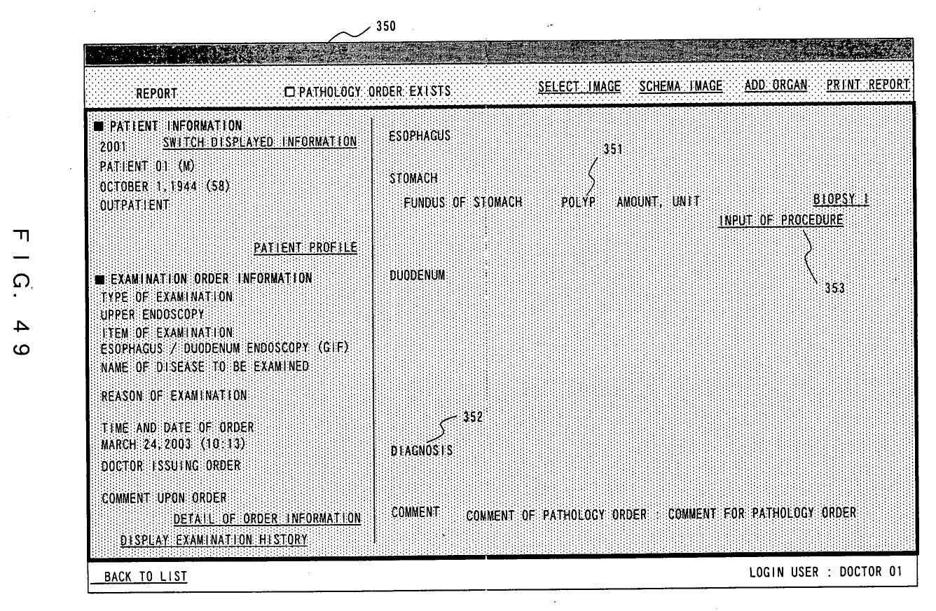

FIG. 49 shows an example of the “Input of report” window for the input of information relating to report remarks, diagnosis and procedure in step S38 and step S42 of FIG. 47.

As shown in FIG. 49, in an “Input of report” window 350, data for each of remarks information 351, diagnosis information 352 and procedure information 353 is input regarding the organ.

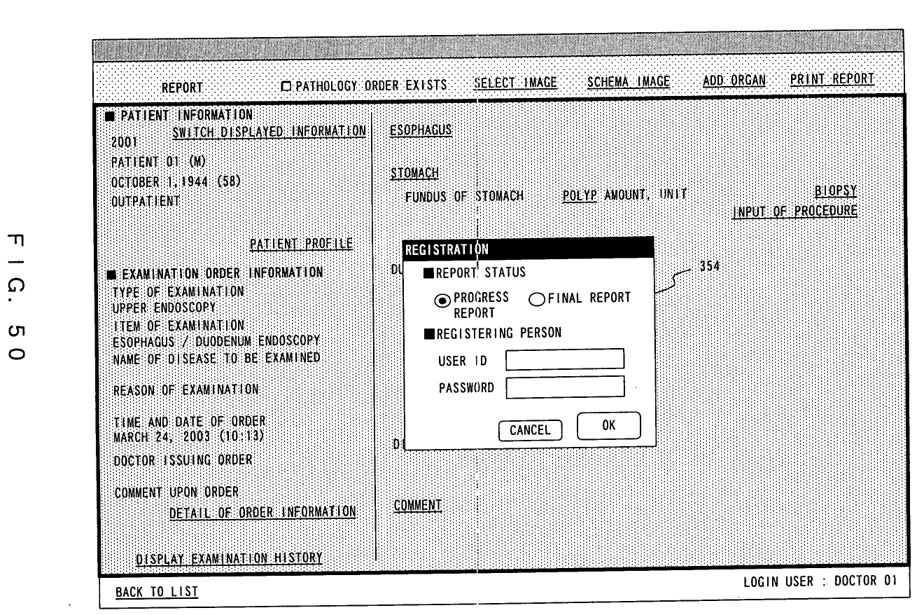

FIG. 50 shows an example of a window for preparing a report and for registering the report in steps S38 and step S42 of FIG. 47.

As shown in FIG. 50, in a window for registering report information 354, a progress report or a final report after the confirmation of the result of pathology is registered. The information of the report is managed in phases of “Progress” or “Final”.

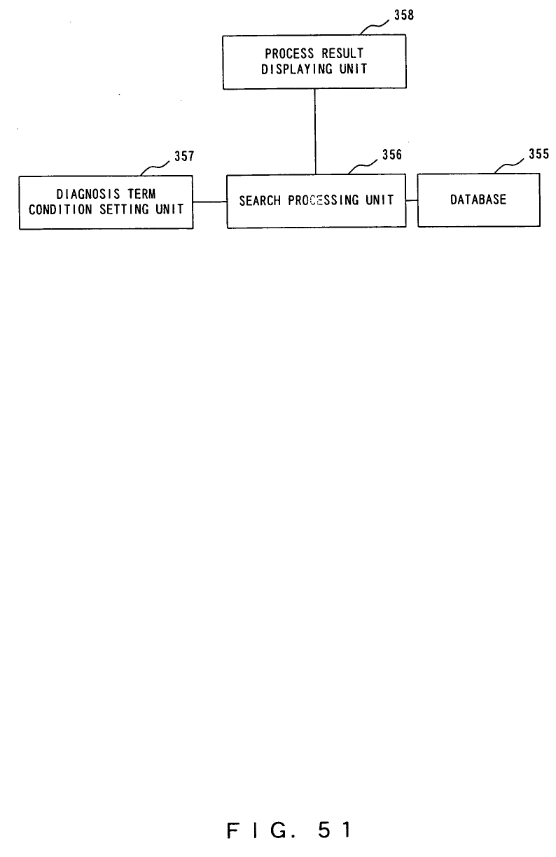

FIG. 51 shows a configuration of process function for realizing the second embodiment of the present invention.

The above configuration comprises a database 355 for storing the data, a search processing unit 356 for searching the database 355 for data, a diagnosis term condition setting unit 357 for setting conditions for conducting the comparison process of the diagnosis term, and a process result display unit 358 for displaying the process result.

In the second embodiment of the present invention, codes of diagnosis terms are recorded in the progress report 324 and the final report 345 as shown in FIG. 44 and are stored in the database 355 shown in FIG. 51. And, when, for example, “Normal” is modified to “Cancer” in each diagnosis term, the search processing unit 356 searches the database 355 and the diagnosis term condition setting unit 357 sets the condition for comparing “Normal” in the progress report 324 and “Cancer” in the final report 325, and the process result display unit 358 displays the result of the search process.

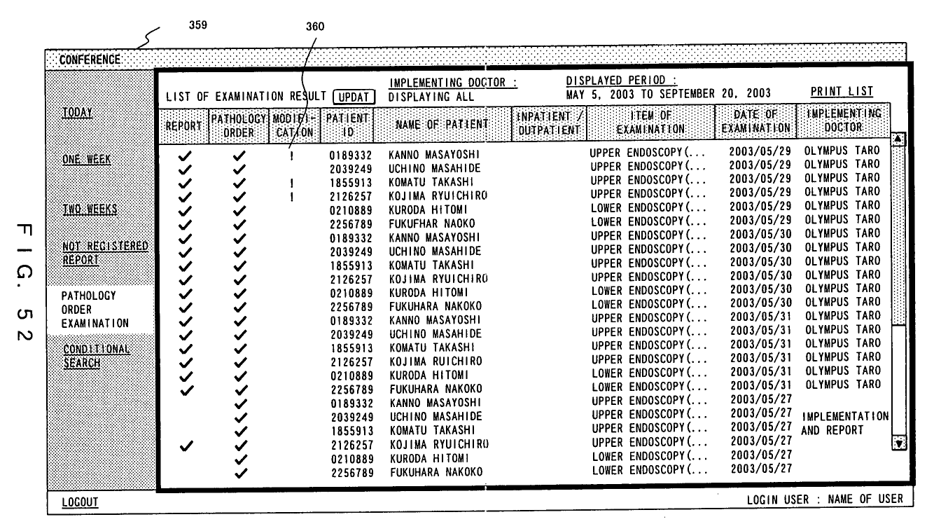

FIG. 52 shows an example of display of the result of the comparison.

In FIG. 52, in a “Conference” window 359, if different results are input between the progress report 324 and the final report 325, for example, in the case that the diagnosis is modified from “Normal” to “Cancer”, an exclamation mark, “!”, is displayed as the “Modification” mark 360 in order to notify (warn) the user.

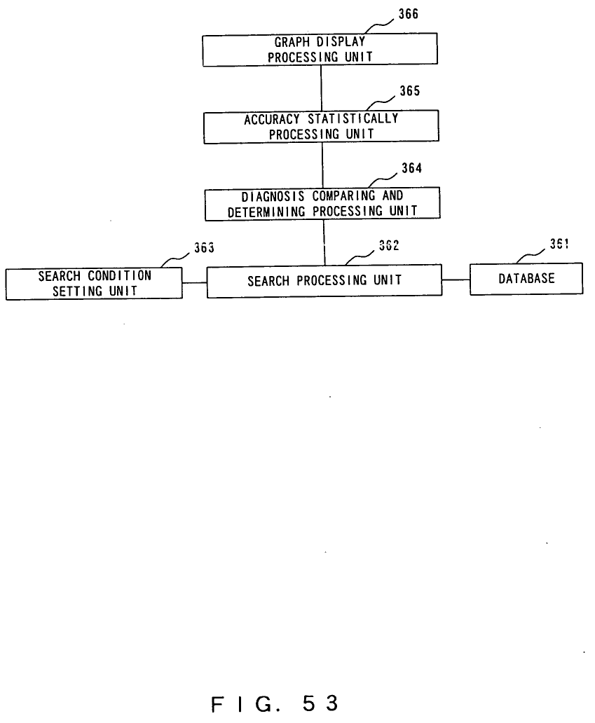

Next, the third embodiment is explained in reference to FIG. 53 to FIG. 61.

FIG. 53 shows a configuration of a process function for realizing the third embodiment of the present invention.

The above configuration comprises a database 361 for storing data, a search processing unit 362 for searching the database 361 for data, a search condition setting unit 363 for setting conditions for conducting the search, a diagnosis comparison and determination processing unit 364 for comparing and determining the diagnosis terms, a statistical accuracy processing unit 365 for statistically processing an accuracy based on the result of the comparison and determination of the diagnosis comparing and determining processing unit 364, and a graph display processing unit 366 for displaying the results of the accuracy statistically processing unit 365.

In the third embodiment of the present invention, in the database 361 of FIG. 53, the implementation management table of FIG. 43, the report management table of FIG. 44, the preprocedure management table of FIG. 45 and the image management table of FIG. 46 are recorded.

For example, in order to calculate the accuracy for each diagnosis, the condition of “Diagnosis” is set in the search condition setting unit 363. Then, based on the keyword of “Diagnosis”, the codes of diagnosis of the progress report 324 and the final report 325 shown in FIG. 44 are compared in order to determine whether or not there is any correspondence between the diagnosis comparison and determination processing unit 364 outputs by the search processing unit 362. Thereafter, the accuracy of the diagnosis is statistically processed by the statistical accuracy processing unit 365 so that the results of the statistical process are displayed as a graph.

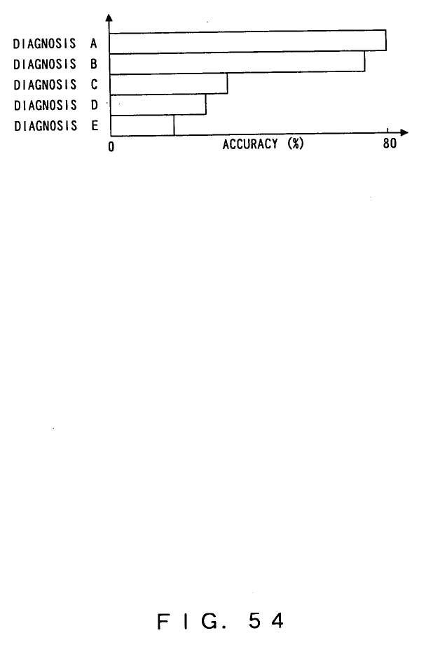

FIG. 54 shows an example of a graph indicating respective accuracies for each disease for which the diagnosis was implemented.

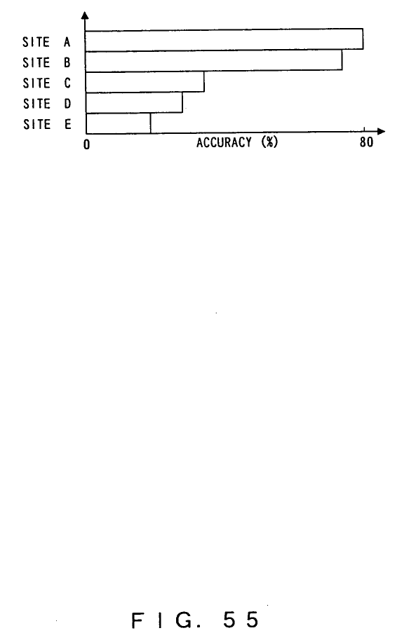

FIG. 55 shows an example of a graph indicating respective accuracies for each site for which the diagnosis was implemented.

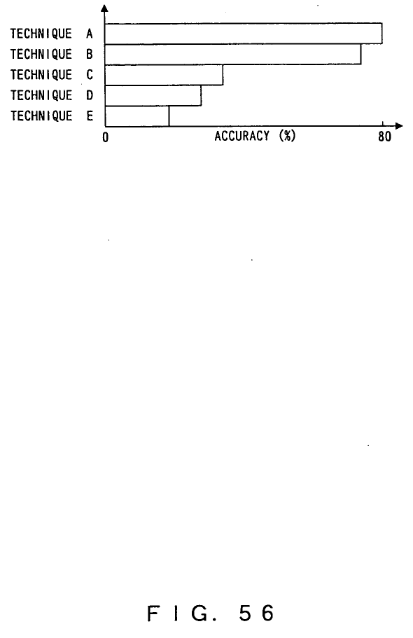

FIG. 56 shows an example of a graph indicating respective accuracies for each implemented technique.

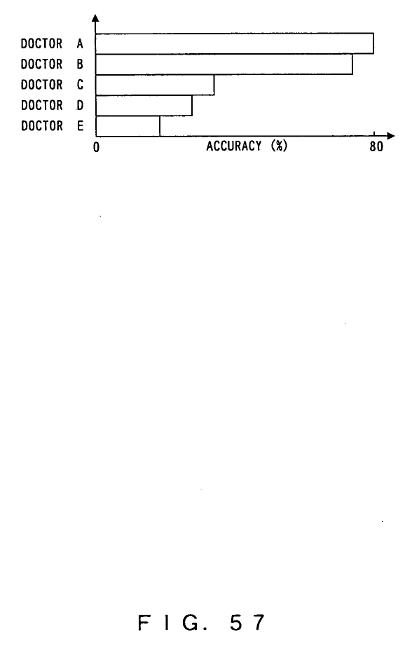

FIG. 57 shows an example of a graph indicating respective accuracies for each doctor.

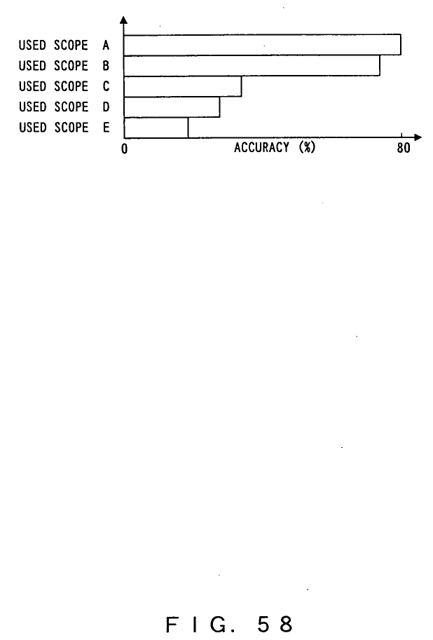

FIG. 58 shows an example of a graph indicating respective accuracies for each used scope.

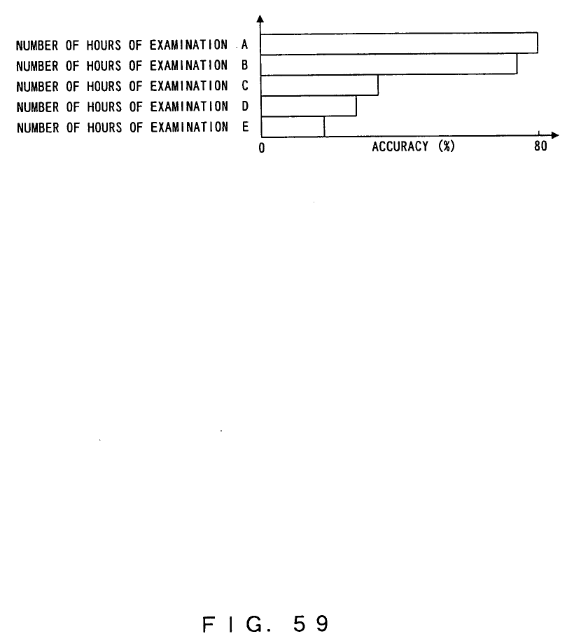

FIG. 59 shows an example of a graph indicating respective accuracies for each number of hours of examination.

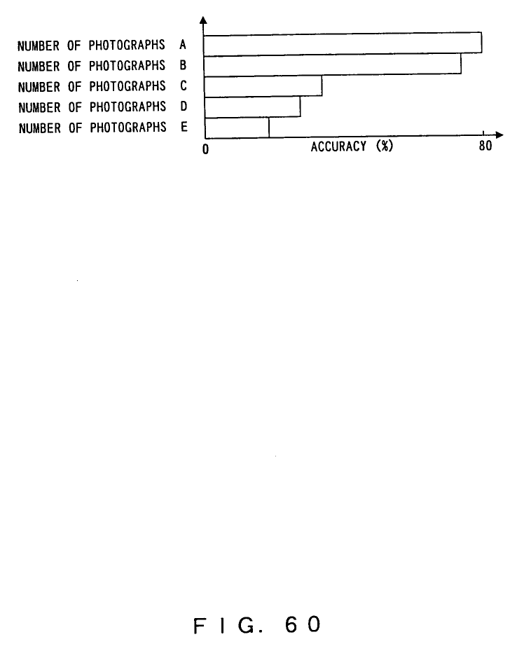

FIG. 60 shows an example of a graph indicating respective accuracies for each number of photographs taken during examination.

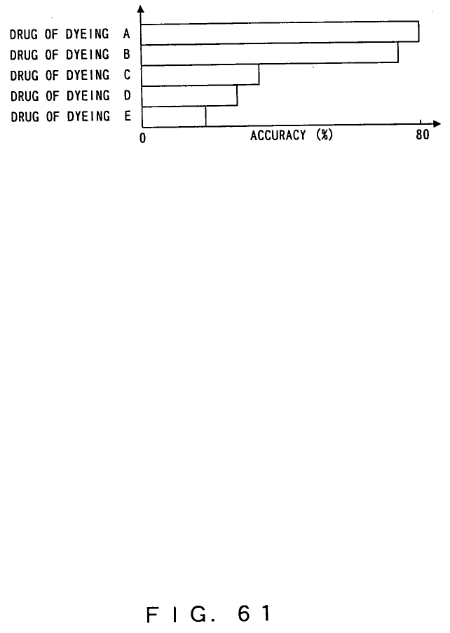

FIG. 61 shows an example of a graph indicating respective accuracies for each drug used to dye the lesion upon diagnosis during examination.

In addition, graphs can be prepared for each instrument or for each drug used for the preprocedure.

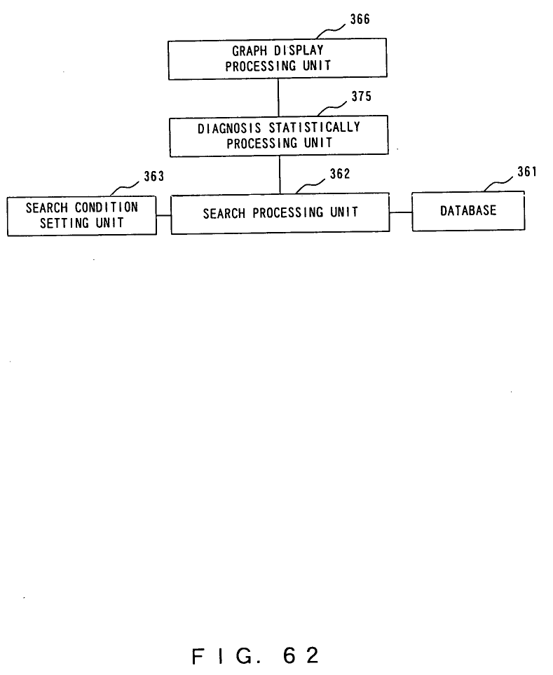

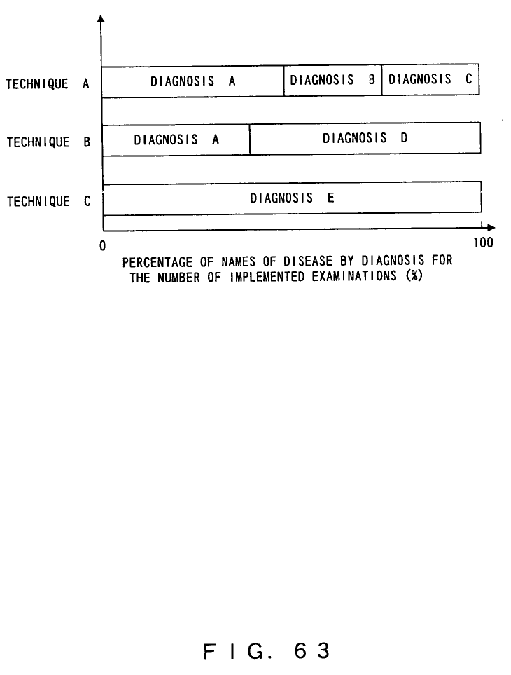

Next, the fourth embodiments are explained by using FIG. 62 and FIG. 63.

FIG. 62 shows a configuration of the process function for realizing the fourth embodiment of the present invention.

The above configuration comprises the database 361 for data storage, the search processing unit 362 for searching the database 361 for data, the search condition setting unit 363 for setting conditions for conducting the search, a diagnosis statistical processing unit 375 for conducting a statistical diagnosis process, the graph display processing unit 366 for displaying the result of the statistical diagnosis process of the diagnosis statistical processing unit 375.

In the fourth embodiment of the present invention, when the condition of implemented “Operation” is set in the search condition setting unit 363 of FIG. 62, a search regarding the name of disease based on the diagnosis of the second follow-up examination is conducted in the search processing unit 362 in the case that, for example, the second follow-up examination is implemented after the first operation, and the search is conducted based on the information regarding the technique associated with the implementation management table of FIG. 43 and the diagnosis information associated with the report managing table of FIG. 44. Thereafter, the percentage of the diagnosis for the number of the implemented examinations is processed in the diagnosis statistical processing unit 375 so that the processed result is displayed as a graph in the graph display processing unit 366.

FIG. 63 shows an example of displaying a breakdown of techniques such as operations by diagnosis.

The embodiments of the present invention have been explained hereinbefore with reference to the drawings, however, it is noted that the invention is not limited to the above explained embodiments and various modifications and various alternations and the like can be made within a scope of the invention and without departing from the spirit of the invention.

1. An examination management system, comprising:
an implemented information input unit for inputting implemented information including information related to a content of implementation of medical service implemented regarding examination and information related to a report of the medical service;
an implemented information storage unit for storing the implemented information input by the implemented information input unit;
an implemented information query unit for obtaining the implemented information related to the report from the implemented information storage unit by entering a key corresponding the patient;
a report comparison unit for comparing to each other a plurality of reports obtained by the implemented information query unit; and
a report comparison result display unit for displaying result of the comparison by the report comparison unit.

2. The examination management system according to claim 1, wherein;
the report includes diagnosis term.

3. An examination management system, comprising:
an implemented information input unit for inputting implemented information including information related to a content of implementation of medical service implemented regarding examination;
an implemented information storage unit for storing the implemented information input by the implemented information input unit;
an implemented information query unit for obtaining the implemented information from the implemented information storage unit by using diagnosis term as a key;
a diagnosis comparison and determination unit for conducting a comparison and a determination of the diagnosis term for the implemented information obtained by the implemented information query unit;
a statistical accuracy processing unit for statistically processing an accuracy based on the implemented information compared and determined by the diagnosis comparison and determination unit; and
a process result display unit for displaying the statistically processed accuracy by the statistical accuracy processing unit.

4. An examination management system, comprising:
an implemented information input unit for inputting implemented information including information related to a content of implementation of medical service implemented regarding examination and information related to a diagnosis term about the medical service;
an implemented information storage unit for storing the implemented information input by the implemented information input unit;
an implemented information query unit for obtaining the implemented information from the implemented information storage unit by using an arbitrary condition as a key;
a statistical diagnosis processing unit for executing a statistical process on the diagnosis term for the implemented information obtained by the implemented information query unit; and
a statistical diagnosis process result display unit for displaying result of the statistical process executed by the statistical diagnosis processing unit

5. A method of managing examination, comprising:
a step of the input of implemented information including information related to a content of implementation of medical service implemented regarding examination and information related to a report about the medical service;
a step of storing the input implemented information in an implemented information database;
a step of obtaining the implemented information related to the report from the implemented information database by using information indicating the same examination of the same patient by a key;
a step of comparing to each other the obtained plurality of reports; and
a step of displaying result of the comparison.

6. The method of managing examination according to claim 5, wherein;
the report includes a diagnosis term.

7. A method of managing examination, comprising:
a step of the input of implemented information including information related to a content of implementation of medical service implemented regarding examination;
a step of storing the input implemented information in an implemented information database;
a step of obtaining the implemented information from the implemented information database by using a diagnosis term as a key;
a step of conducting a comparison and a determination of the diagnosis term for the obtained implemented information;
a step of statistically processing an accuracy based on the compared and determined implemented information; and
a step of displaying the statistically processed accuracy.

8. A method of managing examination, comprising:
a step of inputting implemented information including information related to a content of the implementation of medical service implemented regarding examination and information related to a diagnosis term about the medical service;
a step of storing the input implemented information in an implemented information database;
a step of obtaining the implemented information from the implemented information database by using an arbitrary condition as a key;
a step of executing a statistical process on the diagnosis term for the obtained implemented information; and
a step of displaying result of the statistical process.

9. An examination management system, comprising:
implemented information inputting means for inputting implemented information including information related to a content of implementation of medical service implemented regarding examination and information related to a report about the medical service;
implemented information storage means for storing the implemented information input by the implemented information inputting means;
implemented information query means for obtaining the implemented information related to the report from the implemented information storage means by using information indicating the same examination of the same patient by a key;
report comparison means for comparing to each other a plurality of reports obtained by the implemented information query means; and
report comparison result displaying means for displaying result of the comparison by the report comparison means.

10. An examination management system, comprising:
implemented information inputting means for inputting implemented information including information related to a content of implementation of medical service implemented regarding examination;
implemented information storage means for storing the implemented information input by the implemented information input means;
implemented information query means for obtaining the implemented information from the implemented information storage means by using a diagnosis term as a key;
diagnosis comparison and determination means for conducting a comparison and a determination of the diagnosis term for the implemented information obtained by the implemented information query means;
statistical accuracy processing means for statistically processing an accuracy based on the implemented information compared and determined by the diagnosis comparison and determination means; and
process result display means for displaying the statistically processed accuracy of the statistical accuracy processing means.

11. An examination management system, comprising:
implemented information input means for inputting implemented information including information related to a content of implementation of medical service implemented regarding examination and information related to a diagnosis term of the medical service;
implemented information storage means for storing the implemented information input by the implemented information input means;
implemented information query means for obtaining the implemented information from the implemented information storage means by using an arbitrary condition as a key;
statistical diagnosis processing means for executing a statistical processing of the diagnosis term for the implemented information obtained by the implemented information query means; and
statistical diagnosis processing result displaying means for displaying result of the statistical process executed by the statistical diagnosis processing means.
